(19) United States
(12) Patent Application Publication
(10) Pub. No.: US 2017/0060769 A1
(43) Pub. Date: Mar. 2, 2017

(54) SYSTEMS, DEVICES AND METHODS FOR GENERATING LOCALITY-INDICATIVE DATA REPRESENTATIONS OF DATA STREAMS, AND COMPRESSIONS THEREOF

(71) Applicant: COHO DATA, INC., San Jose, CA (US)

(72) Inventors: Jacob Taylor Wires, Vancouver (CA); Andrew Warfield, Vancouver (CA); Stephen Frowe Ingram, Vancouver (CA); Nicholas James Alexander Harvey, Richmond Hill (CA); Zachary Drudi, Vancouver (CA)

(21) Appl. No.: 15/308,162

(22) PCT Filed: Apr. 29, 2015
(86) PCT No.: PCT/US2015/028253

§ 371 Date: Nov. 1, 2016

Related U.S. Application Data
(60) Provisional application No. 61/987,234, filed on May 1, 2014.

(51) Int. Cl. G06F 12/1018

(52) U.S. Cl. CPC G06F 12/1018; G06F 2212/401

(57) ABSTRACT

Described are various embodiments of systems, devices and methods for generating locality-indicative data representations of data streams, and compressions thereof. In one such embodiment, a method is provided for determining an indication of locality of data elements in a data stream communicated over a communication medium. This method comprises determining, for at least two sample times, count values of distinct values for each of at least two distinct value counters, wherein each of the distinct value counters has a unique starting time; and comparing corresponding count values for at least two of the distinct value counters to determine an indication of locality of data elements in the data stream at one of the sample times.

### FIELD OF THE DISCLOSURE

The instant subject matter relates to the field of generating locality-indicative data representations, and conversion of data streams into representations thereof for determining locality.

### BACKGROUND

SAS/SATA interconnects to PCIe buses marks a remarkable point in the evolution of storage hardware. First generation non-volatile memories offer upwards of 200K IOPS from a single device—an improvement of three orders of magnitude over commodity SAS SSDs. Meanwhile, mechanical disks continue to increase in capacity but not performance, and new technologies like shingled magnetic recording promise to continue this trend. The degree to which progress is advancing in two distinct dimensions is impressive: it would currently require about a thousand mechanical disks to match the IOPS offered by a single PCIe flash card, and it would take nearly a million dollars' worth of PCIe flash (and a steady-state power consumption of over 6,000 W) to match the capacity provided by a single 4U disk enclosure. These extreme disparities lead inevitably to hybrid architectures that draw on the strengths of both media types. While such solutions offer appealing performance and economy, they cannot be effectively deployed in practice without knowledge of the specific workloads they will serve: a mismatch between flash capacity and working set size may result in either excessive cost or disk-bound performance. Miss ratio curves (MRCs) are an effective tool for assessing working set sizes, but the space and time required to generate them make them impractical for large scale storage workloads.

Computer storage and memory are composed in hierarchies of different media with varying efficiency. One common example is the hierarchy of fast CPU cache, slower RAM, and much slower disk. This memory is broken into distinct units called pages. When a new page of memory is moved from a lower, larger and slower level of the hierarchy to a higher, smaller, and faster level of the hierarchy, the older page must be selected to be replaced. The policy for selecting a particular page to be replaced is called the page replacement policy.

One of the metrics for assessing the efficiency of handling a workload in light of this page replacement policy (or similar policies) is the hit/miss ratio, or graphically, the hit-ratio curve or the opposite, the miss-ratio curve, the latter sometimes referred to as “MRC”. The ratio represents the ratio of the number of times that, for example, a data request can be served by the data storage resource that receives it (i.e. a “hit”), to the number of time that, using that same example, a data request cannot be served by such resource (i.e. a “miss”). Such representations can be used to predict the impact of increasing memory capacity on a data storage resource to handle a given workload. It also permits a number of additional operational benefits for managing data storage, particularly in but not limited to data storage systems that comprise scalable and multi-tiered data storage resources. For example, such a curve makes it possible to easily determine how much memory should be added to a higher performing data storage resource before there is a point of diminishing returns (i.e. the relative improvement in performance by adding more memory will not justify the cost associated therewith because, in general, the effect on performance increase becomes relatively lower as the total available memory increases).

Historically, this analysis has been reserved for analyzing the effects of increasing or decreasing cache memory on the performance of processing a workload. In many cases, cache sizes and even higher tier data storage resources, have historically been limited in size and/or performance; as such, there was no limitation on either the size or the analysis time associated with the collection, storage and analysis of workload data streams for generating an MRC (or other similar metric) that would approach a limitation that would impact cache performance. The amount of data, or in some cases the speed of serving that data, associated with known cache sizes and/or existing higher tier memory resources (e.g. flash) were associated with operational limitations that exceeded the operational requirements of determining, processing, and storing MRC (or associated data). Recent developments in higher tier data storage resources, such as PCIe flash, have changed this. In addition, real-time or on-line analysis of data storage resources is now desirable since, for example, some modern data storage systems are including high performance, but expensive, higher tier data storage resources; as such, it is not always an option to store large data sets relating to the hit-/miss-ratio curves and analyze it later.

Moreover, the collection and compression of characteristic data relating to streams of data has broad applicability beyond the hit/miss ratio curves and in data storage. Such characteristic data can be used to determine information regarding streams of data without having access thereto. This may be useful when seeking how to manage large and complex data streams and/or the infrastructure of the associated computing, networking, and storage infrastructure relating thereto. A solution for determining and gathering such characteristics in an efficient manner, and in some cases compressing such data, or storing it a compressed format from which the characteristic data could be determined later, would have myriad uses in understanding data streams within and outside of data storage solutions.

Developments in data storage systems, which are providing tiered solutions that provide differing service levels and costs using scalable data storage resources of varying performance and costs, an ability to align workloads with the correct tier of data storage, possibly at the right time, makes the processing of data in storage systems more efficient, as well as allows significant improvements to the planning and management of such scalable data storage systems. A number of data transmission, data processing, and data storage applications would benefit from the subject matter provided herein.

The many reporting facilities embedded in the modern Linux storage stack are testament to the importance of being able to accurately characterize live workloads. Common characterizations typically fall into one of two categories: coarse-grain aggregate statistics and full request traces. While these representations have their uses, they can be problematic for a number of reasons: averages and histograms discard key temporal information; sampling is vulnerable to the often bursty and irregular nature of storage workloads; and full traces impose impractical storage and processing overheads. New representations are needed which preserve the important features of full traces while remaining manageable to collect, store, and query. Working set theory provides a useful abstraction for describing workloads more concisely, particularly with respect to how they will behave in hierarchical memory systems. In the original formulation, working sets were defined as the set of all pages accessed by a process over a given epoch. This was later refined by using LRU modelling to derive an MRC for a given workload and restricting the working set to only those pages that exhibit strong locality. Characterizing workloads in terms of the unique, ‘hot’ pages they access makes it easier to understand their individual hardware requirements, and has proven useful in CPU cache management for many years. These concepts hold for storage workloads as well, but their application in this domain is challenging for two reasons. First, until now it has been prohibitively expensive to calculate the working set of storage workloads due to their large sizes. Mattson's original stack algorithm required O (N M) time and O (M) space for a trace of N requests and M unique elements. An optimization using a balanced tree to maintain stack distances reduces the time complexity to O (N log M), and recent approximation techniques reduce the time complexity even further, but they still have O(M) space overheads, making them impractical for storage workloads that may contain high numbers of unique blocks. Second, the extended duration of storage workloads leads to subtleties when reasoning about their working sets. CPU workloads are relatively short-lived, and in many cases it is sufficient to consider their working sets over small time intervals (e.g., a scheduling quantum). Storage workloads, on the other hand, can span weeks or months and can change dramatically over time. MRCs at this scale can be tricky: if they include too little history they may fail to capture important recurring patterns, but if they include too much history they can significantly misrepresent recent behavior. This phenomenon is further exacerbated by the fact that storage workloads already sit behind a file system cache and thus typically exhibit longer reuse distances than CPU workloads. Consequently, cache misses in storage workloads may have a more pronounced effect on miss ratios than CPU cache misses, because subsequent re-accesses are likely to be absorbed by the file system cache rather than contributing to hits at the storage layer. One implication of this is that MRC analysis may have to be performed over various time intervals to be effective in the storage domain. A workload's MRC over the past hour may differ dramatically from its MRC over the past day; both data points are useful, but neither provides a complete picture on its own. This leads naturally to the notion of a history of locality: a workload representation which characterizes working sets as they change over time. Ideally, this representation contains enough information to produce MRCs over arbitrary ranges in time, much in the same way that full traces support statistical aggregation over arbitrary intervals. A naive implementation could produce this representation by periodically instantiating new Mattson stacks at fixed intervals of a trace, thereby modelling independent LRU caches with various amounts of history, but such an approach would be impractical for real-world workloads.

A number of methodologies have been developed to calculate exact stack distances. Mattson et al. (see R. L. Mattson, J. Gecsei, D. R. Slutz, and I. L. Traiger. Evaluation techniques for storage hierarchies. IBM Systems journal, 9(2):78-117, 1970) defined stack distances and presented a simple O(NM) time, O(M) space algorithm to calculate them. Bennett and Kruskal (see B. T. Bennett and V. J. Kruskal. LRU stack processing. IBM Journal of Research and Development, 19(4):353-357, 1975) used a tree-based implementation to bring the runtime to O (N log(N)). Almasi et al. improved this to O(N log(M)) (see G. S. Almasi, C. Cascaval, and D. A. Padua. Calculating stack distances efficiently. In Proceedings of the 2002 workshop on memory system performance (MSP '02), pages 37-43, 2002), and Niu et al. (see Q. Niu, J. Dinan, Q. Lu, and P. Sadayappan. Parda: A fast parallel reuse distance analysis algorithm. In Parallel & Distributed Processing Symposium (IPDPS), 2012 IEEE 26th International, pages 1284-1294. IEEE, 2012) introduced a parallel algorithm. Computing exact stack distances remains quite slow, and so a different line of work has derived techniques to efficiently approximate stack distances. Eklov and Hagersten (see D. Eklov and E. Hagersten. StatStack: Efficient modeling of LRU caches. In Performance Analysis of Systems & Software (ISPASS), 2010 IEEE International Symposium on, pages 55-65. IEEE, 2010) proposed a method to estimate stack distances based on sampling. Ding and Zhong (see C. Ding and Y. Zhong. Predicting whole-program locality through reuse distance analysis. In PLDI, pages 245-257. ACM, 2003) use an approximation technique inspired by the tree-based algorithms, but they discard the lower levels of the tree and use only O(log(M)) space to store the tree. Moreover, other data structures used by the algorithm still consume linear space. Xiang et al. (see X. Xiang, B. Bao, C. Ding, and Y. Gao. Linear-time modeling of program working set in shared cache. In Parallel Architectures and Compilation Techniques (PACT), 2011 International Conference on, pages 350-360. IEEE, 2011) define the footprint of a given window of the trace to be the number of distinct blocks occurring in the window. Using reuse distances, they estimate the average footprint across a scale of window lengths. Xiang et al. (see X. Xiang, C. Ding, H. Luo, and B. Bao. HOTL: a higher order theory of locality. In Proceedings of the eighteenth international conference on Architectural support for programming languages and operating systems, pages 343-356. ACM, 2013) then develop a theory connecting the average footprint and the miss ratio, contingent on a regularity condition they call the reuse-window hypothesis. Compared to the preceding methods, data representations disclosed herein have lower memory requirements while producing MRCs with comparable accuracy. A further large body of work explores methods for representing workloads concisely. Chen et al. (see Y. Chen, K. Srinivasan, G. Goodson, and R. Katz. Design implications for enterprise storage systems via multi-dimensional trace analysis. In Proceedings of the Twenty-Third ACM Symposium on Operating Systems Principles, pages 43-56. ACM, 2011) use machine learning techniques to extract workload features. Tarasov et al. (see V. Tarasov, S. Kumar, J. Ma, D. Hildebrand, A. Povzner, G. Kuenning, and E. Zadok. Extracting flexible, replayable models from large block traces. FAST, 2012) describe workloads with feature matrices. Delimitrou et al. (see C. Delimitrou, S. Sankar, K. Vaid, and C. Kozyrakis. Decoupling datacenter studies from access to large-scale applications: A modeling approach for storage workloads. In Workload Characterization (IISWC), 2011 IEEE International Symposium on, pages 51-60. IEEE, 2011) model workloads with Markov Chains. These representations are largely orthogonal to data representations disclosed herein—they capture many details that are not preserved in counter stack streams, but they discard much of the temporal information required to compute accurate MRCs. Many domain-specific compression techniques have been proposed to reduce the cost of storing and processing workload traces. These date back to Smith's stack deletion (see A. J. Smith. Two methods for the efficient analysis of memory address trace data. Software Engineering, IEEE Transactions on, 3(1):94-101, 1977) and include Burtscher's VPC compression algorithms (see M. Burtscher, I. Ganusov, S. J. Jackson, J. Ke, P. Ratanaworabhan, and N. B. Sam. The vpc trace compression algorithms. Computers, IEEE Transactions on, 54(11):1329-1344, 2005). These methodologies generally preserve more information than counter stacks but achieve lower compression ratios, and they do not offer new techniques for MRC computation.

Among other benefits, there is provided herein various devices, methods, software architectures, computer-readable media with instructions encoded thereon, and systems for, inter alia, generating data representations for providing indications of locality from a data stream of discrete data elements, analyzing such data representations, managing data storage resources and other data, computing, networking, and communications resources, associated with such data streams, and compressing information from some data streams capable of building such data representations.

This background information is provided to reveal information believed by the applicant to be of possible relevance. No admission is necessarily intended, nor should be construed, that any of the preceding information constitutes prior art.

### SUMMARY

The following presents a simplified summary of the general inventive concept(s) described herein to provide a basic understanding of some aspects of the invention. This summary is not an extensive overview of the invention. It is not intended to restrict key or critical elements of the invention or to delineate the scope of the invention beyond that which is explicitly or implicitly described by the following description and claims.

A need exists for systems, methods and devices for methods, systems and devices for parallel network interface data structures with differential data storage service capabilities that overcome some of the drawbacks of known techniques, or at least, provide a useful alternative thereto. Some aspects of this disclosure provide examples of such methods, systems and devices.

There is provided herein, in one embodiment, a data structure which is representative of a data stream and, in turn, can be used to generate approximate MRCs, and other data constructs, in sublinear space, making this type of analysis feasible in the storage domain. In some embodiments, such data structures can be generated and/or stored and/or assessed in real time and/or remotely from the data resource with which the data stream is associated. In some embodiments, the data structures use probabilistic counters to estimate count values in distinct value counters. In some embodiments, the approach to generating MRCs is based on the observation that a block's ‘stack distance’ (also known as its ‘reuse distance’, and can be considered to be the count of elements in a data stream before that same block is accessed again) gives the capacity needed to cache it, and this distance is exactly the number of unique blocks accessed since the previous request for the block. Once aspect behind counter stacks is that probabilistic counters can be used to efficiently estimate stack distances without maintaining an actual count for all elements in a data stream. This allows computation of approximate distinct value counters, and subsequently MRCs or other data constructs (such as counts of unique values, histograms relating to the number of requests related to any given data element) at a fraction of the cost (i.e. processing resources) of traditional techniques.

In one embodiment there is provided, inter alia, a technique for estimating miss ratio curves using a data representation indicative of locality; in some cases, with determinable and adjustable performance and accuracy. In addition, such data representations in some embodiments may be periodically checkpointed and streamed to disk to provide a highly compressed representation of storage workloads thereby, in some cases, capturing important details that are discarded by statistical aggregation while at the same time requiring orders of magnitude less storage and processing overhead than full request traces.

In accordance with one aspect, there is provided a method for determining an indication of locality of data elements in a data stream communicated over a communication medium, the method comprising: determining, for at least two sample times, count values of distinct values for each of at least two distinct value counters, wherein each of the distinct value counters has a unique starting time; and comparing corresponding count values for at least two of the distinct value counters to determine an indication of locality of data elements in the data stream at one of the sample times. In some embodiments, the step of comparing corresponding values includes identifying for at least one sample time the distinct value counter having the most recent unique starting time whose count increases by less than a predetermined value from the previous sample time and for which an adjacent younger distinct value counter increases by more than the predetermined value.

In accordance with another aspect, there is provided a method for converting at least one data stream of data elements on a communications medium into a data stream representation for providing an indication of locality of the data elements, the data stream representation comprising a plurality of distinct value counters, each distinct value counter having a unique count start time, the method comprising: selecting a starting count time for the data stream; for each of a plurality of distinct value counters commencing after the starting count time, determining at a first sample time a current count value; storing the count value and sample time for each distinct value counter in the data stream representation; and repeating the determining and storing steps for at least one other sample time.

In accordance with another aspect, there is provided a system for generating a data representation of workload characteristics of a data stream being processed on a data resource, the data stream comprising a plurality of data elements, the system comprising: a data storage component for storing a data representation of the data stream, the data representation indicative of locality of the data elements; a computer processing component configured to: generate, for at least two sample times, a counter value from each of a plurality of distinct value counters for the data stream, each distinct value counter having a unique start time, and store the counter value and sample time for each distinct value counter in the data storage component. In some embodiments, the computer processing component may be configured to compare the distinct value counters to determine locality of the data stream. The locality of the data stream may include miss ratio information, hit ratio information, uniqueness of data elements in a data stream, stack distance, stack time, or another indication of locality. The comparison of distinct value counters may comprise identifying at any given sample time the distinct value counter which increases from the previous sample time by a value that is equal or less than a predetermined value and for which the younger adjacent distinct value counter (where “younger” is determined to be the distinct value counter having the more recent unique starting time and “adjacent” is the distinct value counter with the next unique start time) increases by more than the predetermined value from the previous sample time; in such embodiments, wherein the time since the last time the data element associated with the first sample time was in the data stream is equal to the unique starting time of that distinct value counter and the number of data elements in the data stream since that data element was in the data stream (i.e. stack distance) is the count value or approximately the count value.

In accordance with another aspect, there is provided a method for converting at least one data stream into a probabilistic representation of the at least one data stream, the representation indicative of a probabilistic locality of data elements of the at least one data stream, the method comprising: for a first data element in a first data stream of the at least one data stream, calculating a probabilistic hash function result at a first sample time; generating from the probabilistic hash function result, a locality indicative value and a probabilistic register address; storing the locality indicative value, probabilistic register address, and the sample time; repeating the calculating and generating steps for at least one other data element at another sample time. In some aspects, the method further comprises the steps: generating a probabilistic register for a selected time interval associated with the at least one data streams by placing the locality indicative value associated with the largest sample time that is within the selected time interval into the probabilistic register at the probabilistic register address; and calculating a probabilistic counter value from the probabilistic register.

Each of the preceding methods may be associated with computer-readable storage media, upon which a set of instructions corresponding to methods provided for herein may be written. Such embodiments may include data storage and/or data processing and/or and data stream interfacing components which implement such instructions.

Storage system implementors face very challenging problems in managing resources. When deploying new systems, it is difficult to appropriately size fast non-volatile memory relative to slower capacity-oriented tiers without a detailed understanding of application workloads and working set expectations. Within running systems, it is hard to make effective online resource allocation decisions in order to partition high-performance memories between competing workloads. Techniques such as miss ratio curve estimation have existed for decades as a method of modeling such behaviors offline, but their computational and memory overheads have prevented their incorporation as a means to make live decisions in real systems.

Some embodiments disclosed herein may address some of these issues, as well as other benefits that may or may not be disclosed herein. Some of the data representations disclosed herein permit locality characterization that can allow workloads to be studied in new interactive ways, for instance by searching for anomalies or shifting workloads to identify pathological load possibilities. They can also be incorporated directly into system design as a means of making more informed and workload-specific decisions about resource allocation across multiple tenants.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 represents a typical hit-/miss-ratio curve used for assessing workload characteristics for a data stream on data storage resources;

FIG. 2 shows an exemplary data stream with distinct value counters in accordance with an embodiment hereof;

FIG. 3 shows an exemplary data representation in accordance with one embodiment showing pruning of the data representation;

FIG. 4 shows an exemplary graphical representation of an embodiment of the architecture of a system for generating data representations indicative of locality in accordance with aspects disclosed herein;

FIG. 5 shows exemplary data structures indicative of uncertainty associated with counter stack data structures that have been binned in accordance with aspects disclosed herein;

FIG. 6 shows a set of MRC associated with workloads from a well-studied collection of storage traces released by Microsoft Research in Cambridge, some of which are calculated in accordance with aspects disclosed herein;

FIG. 7 shows a set of MRCs for various combinations of MSR workloads produced by a join operation in accordance with aspects disclosed herein;

FIG. 8 shows a set of MRCs associated with a time-sliced workload in accordance with aspects disclosed herein;

FIG. 9 shows an MRC associated with Best and worst time-shifted MRCs for MSR calculated in accordance with aspects disclosed herein;

FIG. 10 shows an exemplary data construct showing total and unique requests per unit time determined from a data representation of locality of a workload in accordance with aspects disclosed herein;

FIG. 11 shows an exemplary set of MRCs for three permutations of a single zipfian distribution of a workload generated by a synthetic workload generator, the MRCs calculated from a data representation of the synthetic workload in accordance with aspects disclosed herein;

FIG. 12 shows an exemplary compression pseudo-register for reconstructing probabilistic counter values during any time interval along with the resulting reconstructed and filtered register;

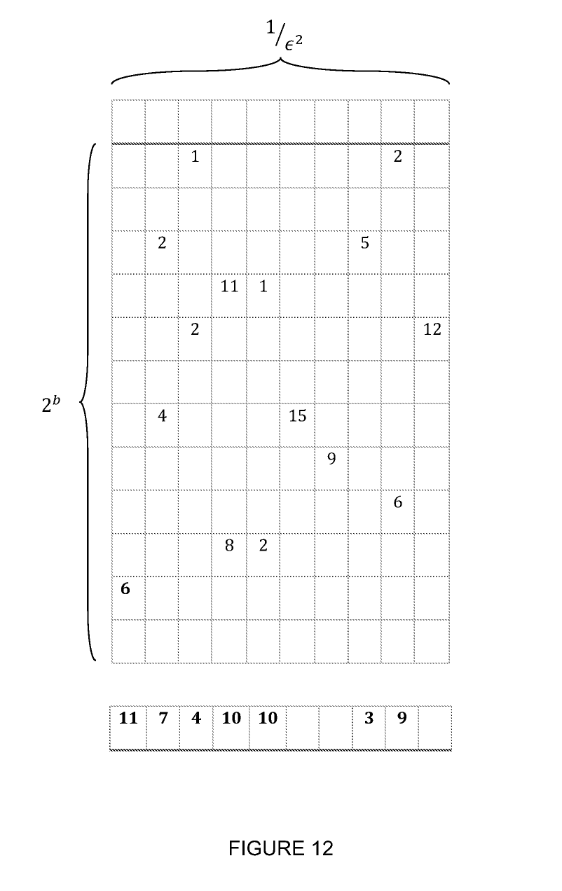

FIG. 13 shows another set of MRCs for various combinations of MSR workloads produced by a join operation in accordance with aspects disclosed herein; and

FIG. 14 shows an aggregated hit-/miss-ratio curve used for partitioning workload characteristics for an aggregate data stream on data storage resources using a solver module in accordance with aspects disclosed herein.

### DETAILED DESCRIPTION

Existing techniques for identifying working set sizes based on miss ratio curves (MRCs) have large memory overheads which make them impractical for storage workloads. There is provided herein a data structure and data structure methodology, as well as associated devices and systems, which can be used to produce approximate MRCs while using sublinear space. These data structures can be checkpointed to produce workload representations that are many orders of magnitude smaller than full traces. In other embodiments, there are provided techniques for estimating MRCs of arbitrary workload combinations over arbitrary windows in time. In some embodiments, there is provided online analysis of data streams using these data structures that can provide valuable insight into live workloads.

The subject matter provided herein relates in part to the collection, compression, and analysis of distinct value counters. By calculating a plurality of distinct value counters for a data stream, each such counter having unique and possibly known start times, and then comparing them, one can determine with a known or acceptable level of uncertainty, inter alia, (a) when distinct values have occurred in a data stream and/or whether there are a high number of distinct values in a given data stream; (b) the likelihood of any element in a data trace being repeated in a data stream; (c) the locality of elements in a data stream; (d) the locality of data relating to an element in a data stream and/or a workload existing in or associated with one or more tiers of storage; and (e) stack distance and stack time in a data stream or portion thereof. Moreover, characteristic representations of data streams, which may in some embodiments provide an indication of an associated data stream, may be combined, divided, offset, and/or intersected, and then compared, to determine the effect of carrying out such combinations, divisions, offsets, intersections of the associated data stream or data streams; in some embodiments, real time assessment or data representation generation may be carried out; in some embodiments, the data stream may be converted into a representation of the data stream which is stored or transmitted thus permitting such analyses without having access to either or both of the raw data stream or the data storage facility (or other data processing facility or device).

In an exemplary embodiment, a data stream comprises a stream of consecutive and/or discrete data elements (or aspects, components, or descriptors of data elements, such as IP addresses or block addresses relating to data units) or identifiers relating to physical elements (i.e. an identifiable thing or device or occurrence or condition relating to such thing or device); a representation thereof which is indicative of locality may in some cases be generated from the data stream by generating and comparing a count, or an estimate of a count, of the number of times a particular data element has occurred in a given time interval in the data stream. The data elements may be sampled in the data stream at regular intervals or irregular intervals, and are generally associated with a sample time (sample time refers to the time at which a data element is detected in a data stream at, for example, a receiving node or a sending node or an intermediate node). In some embodiments, data elements are processed by a processor, data storage resource, or other data resource, at regular or determinable time intervals as they “hit” or are “seen” or are processed by or occur at that resource. A distinct value counter (sometimes referred to herein as “DVC” or a distinct data element counter) may be started for every data element in a data stream or at any given time during the data stream, and counts the number of distinct values that have occurred in the data stream since the beginning of that distinct value counter. Such distinct value counters are associated with a count value, equal to, or an estimate of, the number of distinct data elements in a data stream since the beginning of the distinct value counter, as well as by a starting time. For example, the data stream comprising the set of data elements E, where E comprises {a, b, d, c, a, d, d, e, f}, would result in, as an example, DVC₁{1, 2, 3, 4, 4, 4, 4, 5, 6}, where DVC₁ has a starting time of t=0 and t=0 is associated with the first data element in the stream; the same data stream may produce another distinct value counter, DVC₂{1, 2, 3, 4, 4, 4, 5, 6}, where DVC₂ has a starting time of t=1 that is associated with the second data element in the data stream. In some embodiments, the methods, systems, and devices herein may be configured to collect all possible distinct value counters for a given data stream, that is with a new unique distinct counter beginning with each or a different data element and which refreshes the count for each counter with every new data element by (i) increasing if such data element has not occurred in the data stream since the beginning of that counter, or (ii) remaining the same if the data element has occurred previously at least once in the data stream since the beginning of that counter.

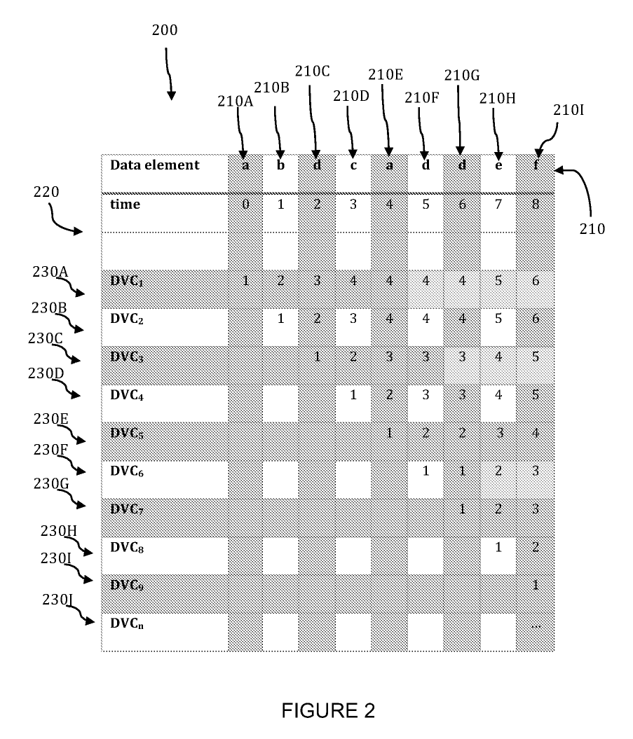

With reference to FIG. 2, a data representation showing all the possible DVCs for the data stream 210 wherein a new DVC has been started with receipt (or transmission, sampling, or detection, e.g.) of every data element (210A through 201I) in the data stream 210. For every DVCₙ, where n is the n^{th} distinct value counter, there has been a sample collection for every data element. In the example shown, a data element is detected at every unit time 220, but in some cases (not shown), data elements may be detected at irregular time intervals. A number of useful aspects of information can be gleaned from this data representation 200 by comparing the DVCs (230A through 230J), including the number of elements in the data stream since the last time an element was sampled (i.e. stack distance) and the time elapsed since the time it was last sampled (e.g. stack time). The following specific observations can be determined from the set of DVCs for a given data stream: If a given DVC, working from newest to oldest, is the first DVC to not increase at a given time interval, then (1) the last observation of that data element will be the start time of that DVC and (2) the value of that DVC is the stack distance for that element. For example, consider the first non-distinct element in the data structure 200, which occurs at t=4 where “a” occurs in the data stream for the second time; DVC₁ remains at 4 from t=3 to t=4, while the remaining DVCs continue to increase. The counter value at DVC₁ (t=4) is 4, the data element is “a,” and there is no newer DVC whose values remain the same from t=3 to t=4 (i.e. DVC₂ increases at the same interval and therefore DVC₁ is the first distinct value counter to remain the same); this means that “a” was last experienced at the start time for DVC₁, which was t=0, and the stack distance since the last “a” is 4. Continuing forward, the next element, “d” was also previously experienced. DVC₃ at time (t=5) is the newest DVC to not increase; it can be thus determined that the element “d” was previously experienced at the start time of DVC₃ (t=2) and the stack distance was 3. This example shows how a plurality of distinct value counters can be used to determine important characteristics of data streams, including, the time elapsed (i.e. stack time) and number of elements since a given data element was last experienced or detected in a data stream (i.e. stack distance). In this embodiment, the indication of locality is provided by these values, namely, stack time and stack distance.

Stack times can be understand as the elapsed clock time since a given element was last detected in a data stream; it can be understood as the age of a given element before being detected in a stream again, where age is measured in units of time, or number of data elements (in some cases the frequency of units is regular, semi-regular, or can be assumed to be regular or semi-regular over a period of time); as such, age or elapsed time can be measured in number of elements (in which case, stack time and stack distance are similar; this is however, not always the case). Stack times can be collected and analysed, possibly but not limited to, similar or analogous ways that stack distance is analysed, as well as other ways. For example, stack times for data elements in data streams can be collected and then used to better understand the age or vintage of data elements in a workload, including by generating histograms, cumulative distribution functions, or other data representations known to persons skilled in the art that may be used to assess or detect operational characteristics associated with processing data streams.

In embodiments, it is possible to partition a given set of storage resources across specific workloads in a global set of data storage transactions wherein portions of memory for specific tiers of data storage are specifically designated for each workload, groups of workloads, or combinations thereof, from the aggregate workload on a data storage system. In some embodiments, an MRC can be determined for an aggregated workload (i.e. for all workloads concurrently sharing the same set of data storage resources). Portions in time of such aggregated workload can be “sliced” to assess an MRC for a particular workload for a particular time interval (since the MRC curve for a given time interval may be very different for another time interval, even an overlapping one, for the same workload). In another embodiment, the workloads can be disaggregated, and assessed by determining the MRC for each workload individually so as to determine the best partition size of available cache.

While some embodiments may utilize such a complete set of counters (i.e. a new DVC beginning with every data element in a data stream and calculating a new count with every sample time), some embodiments will not collect data for every data element, nor will there will be a DVC being initiated at all data elements (or all possible sample times) in all embodiments. In some cases, the amount of data being stored at each iteration will increase significantly as the size of the data stream increases because of the size of the data stream. Accordingly, as data streams become very large (i.e. the number of data elements that stream is very high), the amount of data required to be collected, maintained, processed and stored may become prohibitive. As such, a number of techniques are employed herein to reduce the amount of data that must be collected and stored to determine locality on the basis of comparing DVCs. For some of these techniques, the observation that in some cases cardinality information of an element in a given data stream (including information relating to the count of distinct values in the data stream since the count started) can be within a sufficiently accurate estimation and/or within a particular confidence interval and remain more than adequate to perform analyses of the data stream characteristics, such as constructing a hit-ratio or miss-ratio curve. In other words, knowing that (i) a predicted value of a given DVC is within ±ε of the actual value of that DVC, and/or (ii) the predicted value of a given DVC will be within specific or generally understood upper and lower bounds of the actual value of that DVC, will be more than enough to determine locality information of the data stream and its constituent elements, sufficient to be used, for example, to build MRCs to predict the effect of adding or reducing memory resources of a given storage tier (i.e. flash and/or cache) for a given workload thereon.

One example of these techniques for reducing the number of data required for generating, storing and processing DVCs, includes the use of probabilistic counters for calculating counter values at any given time, which makes it possible to estimate within a known error limit all of the counter values at any given time without having calculated and/or stored all prior entries in the set of all possible counters for a given data stream; one example of such probabilistic counters may be HyperLogLog (hereinafter “HLL”).

Another example of data reduction techniques is binning. In a first type of binning, each DVC does not collect or store counter values for all data elements and/or all possible time intervals. For example, in FIG. 2, an embodiment may utilize DVCs that only determine and store count values for t=0, 2, 4, 6, etc., indicated by the data elements in the grey columns 210A, 210C, 210E, 210G, 210I). In another type of binning, not all possible unique distinct value counters are calculated, wherein a time interval may be permitted between starting new unique DVCs. With reference to FIG. 2, for example, only DVC₁, DVC₃, DVC₅, DVC₇, and DVC₉ are calculated, as shown by the DVCs in the grey rows, 230A, 230C, 230E, 230G, 230I). Such binning therefore provides that at any given time, stack time and stack distance may be determined, albeit as being a predicted value that is within a possible range of values. These types of binning may be used on their own or concurrently. Although the use of this binning may introduce some degree of additional uncertainty, since it becomes impossible to determine when a DVC increased between bins, this uncertainty will be (a) known; (b) less than is required to determine locality with sufficient certainty; (c) mitigated by a large enough number of samples; or (d) a combination thereof.

Another example of data reduction techniques, includes ceasing the calculation and/or storage of values from any older DVC if a newer DVC becomes equal (or close enough for the purposes of the appropriate data analysis) to that older DVC; once a DVC becomes equal to a prior DVC, they will always be the same and so the data of the older DVC becomes redundant. If an estimate of the value is permissible for the purposes of determining an indication of locality information with sufficient accuracy, then the counter data of the older DVC may also be redundant, even if it is not exactly the same. With reference to FIG. 2, DVC₁ and DVC₂ have the same counter values from t=5 to t=8 210F to 210I shown in light grey; since these values will never deviate from one another, the corresponding values from DVC₁ need not be stored (or indeed calculated) since they can be assumed to be the same as DVC₂. In some embodiments, the values may be dropped when the difference between adjacent collected distinct counter values is within a predetermined or calculated value.

Using the above-described data structures, it becomes possible to determine characteristics relating to a given data stream that can be used thereafter or in real-time to determine information relating to the uniqueness and/or cardinality of data elements in a given data stream, to determine the locality of data elements in the data stream, to determine stack distance for data elements in a data stream, to build hit-/miss-ratio statistics for a given data stream or workload, to determine the effects of adding or removing memory resources for a data storage workload associated with a given data stream or workload, to predict the effects combining separate data streams or workloads, to predict the effect of separating workloads, to predict the effect of changing and/or offsetting the start times of separate data streams or workloads that may been combined, to predict the effects of separating portions of data streams or workloads into different or distinct times, to assess or predict when and why data streams or workloads may be experiencing resource constraints, over- or under-capacity, or other performance issues, and/or to generally diagnose workload performance in a given data storage facility or aspect thereof; all of the preceding becomes possible without having access to the actual data streams or workloads or the data storage resources or data storage facility. Only the data structures that represent the distinct value counters, or structures capable of reconstructing the distinct value counters, are required. As such, methods, devices and systems relating to the generation of such data structures are provided, as are methods, devices and systems relating to the use of such data structures in managing data storage facilities and data storage resources thereof, as well as other data processing requirements.

The data representations that are indicative of locality in some embodiments may include counter stacks. Such counter stacks capture locality properties of a sequence of accesses within an address space. In the context of a storage system, accesses are typically read or write requests to physical disks, logical volumes, or individual files. A counter stack can process a sequence of data elements, such as data requests (i.e. read, write, update requests) as they occur in a live storage system, or it can process, in a single pass, a trace of a storage workload. One objective of a counter stack is to represent specific characteristics of the stream of requests in a form that is efficient to compute and store, and that preserves enough information to further characterize aspects of the workload, such as cache behaviour. Rather than representing a trace as a sequence of requests for specific addresses, counter stacks maintain a list of counters, which are periodically instantiated while processing the trace. Each counter records the number of unique trace elements observed since the inception of that counter; this captures the size of the working set over the corresponding portion of the trace. Computing and storing samples of working set size, rather than a complete access trace, yields a very compact representation of the trace that nevertheless reveals several useful properties, such as the number of unique blocks requested, or the stack distances of all requests, or phase changes in the working set. These properties enable computation of MRCs over arbitrary portions of the trace. Furthermore, this approach supports composition and extraction operations, such as joining together multiple traces or slicing traces by time, while examining only the compact representation, not the original traces.

A counter stack may be characterized as an in-memory data structure that is updated while processing a trace. At each time step, the counter stack can report a list of values giving the numbers of distinct blocks that were requested between the current time and all previous points in time. This data structure evolves over time, and it is convenient to display its history as a matrix, in which each column records the values reported by the counter stack at some point in time. Formally, given a trace sequence (e₁, . . . , e_{N}), where eᵢ is the i^{th} trace element, consider an N×N matrix, C, whose entry in the i^{th} row and j^{th} column is the number of distinct elements in the set {e₁, . . . eⱼ}. For example, the trace (a; b; c; a; b; c) yields the following matrix.

$$( \underline{\begin{matrix}a , & b , & c , & a , & b , & c\end{matrix}} )$$

$$\begin{matrix} 1 & 2 & 3 & 3 & 3 & 3 \\ & 1 & 2 & 3 & 3 & 3 \\ & & 1 & 2 & 3 & 3 \\ & & & 1 & 2 & 3 \\ & & & & 1 & 2 \\ & & & & & 1\end{matrix}$$

The j^{th} column of this matrix gives the values reported by the counter stack at time step j, i.e., the numbers of distinct blocks that were requested between that time and all previous times. The i^{th} row of the matrix can be viewed as the sequence of values produced by the counter that was instantiated at time step i. The in-memory counter stack only stores enough information to produce, at any point in time, a single column of the matrix. To compute the desired properties over arbitrary portions of the trace, the entire history of the data structure, i.e., the entire matrix, may be stored in some embodiments. However, the history does not need be stored in-memory. Instead, at each time step the current column of values reported by the counter stack is written to disk. This can be viewed as checkpointing, or incrementally updating, the on-disk representation of the matrix.

In embodiments, there are provided methods (and related devices and systems) for determining an indication of locality of data elements in a data stream, the method comprising: determining, for at least two sample times, count values of distinct values for each of at least two distinct value counters, wherein each of the distinct value counters has a unique starting time; and comparing corresponding count values for at least two of the distinct value counters to determine an indication of locality of data elements in the data stream at one of the sample times. In some embodiments, the comparing of corresponding values may comprise, for a first sample time in the at least two sample times, identifying the oldest distinct value counter at the first sample time for which both of the following are true: the count value has increased less than a predetermined value since the previous sample time, and the count value for the adjacent distinct value counter that has a more recent starting time has increased by more than the same predetermined value. In some cases, the predetermined value may be 0 or greater. In some cases, the predetermined value may reflect the degree to which the data representation has been binned and/or the predetermined certainty associated with the probabilistic counter used to calculate the distinct value counter at the first sample time.

There is further provided in another embodiment a method for characterizing a data stream of discrete data elements, the method comprising: defining a plurality of distinct data element counters each for respectively counting distinct data elements in said data stream over time, wherein each said data element counters have unique start times; determining respective increases between successive counts for at least two adjacent ones of said distinct data element counters; comparing corresponding increases determined for said at least two adjacent ones of said distinct data element counters to output an indication as to a locality of at least some of the discrete data elements in the data stream as a result of said data element counters having unique start times; and outputting said indication to characterize the data stream. In some embodiments, such method may further comprise determining an indication of an upper bound and a lower bound to said locality as a function of: counting time interval magnitudes between said successive counts for said at least two consecutive ones of said distinct data element counters, starting time interval magnitudes between said unique start times for at least two adjacent distinct data element counters. In some embodiments, such method may further comprise probabilistic distinct data element counters. In some embodiments, such method may further comprise ceasing the step of determining respective increases between successive counts of any of the distinct data element counters when the successive counts for any such distinct data element counters are equal to the adjacent distinct data element counters with a different unique start time. Only one of the distinct data element counters need be determined since the others may be deemed to be the same once they converge to the same count.

In embodiments, there are provided methods, as well as related devices and systems, for converting a data stream of data elements on a communications medium into a data stream representation for providing an indication of locality of the data elements, the method comprising: Selecting a starting count time for the data stream; for each of a plurality of distinct value counters starting after the starting count time, determining at a first sample time a current counter value, wherein each of the distinct value counters has a unique starting time; Storing the counter value for each distinct value counter in a data storage resource; and repeating the determining and storing steps for at least one other sample time.

In embodiments, there are provided devices for converting a data stream of data elements being communicated over a communications medium into a locality representation, the locality representation for generating indications of locality of the data elements, the device comprising a computer processing component, a data storage component, and data stream interfacing component; the data storage component for storing a data representation of the data stream, the data representation indicative of locality of the data elements; the computer processing component configured to generate, for at least two sample times, a counter value from each of a plurality of distinct value counters for the data stream, each distinct value counter having a unique start time and the computer processor component further configured to store the counter value and sample time for each distinct value counter in the data storage component.

In some embodiments, the device further comprises a communications interfacing component that provides for a communications interface for a data resource on or associated with the device (wherein such data resource may comprise of a data storage facility and/or data storage resources therein, a data processor, or other data resources); in some cases, the communications interface component may provide an interface at the device between the data resource and a communication network and/or other devices and nodes in a network. The communications interface component may in some embodiments provide for the device to receive or transmit a data stream that is transmitted to or from a data resource, and/or is processed on the data resource (including by processing data requests, such as read or write requests to data storage resources associated with the data resource). In some embodiments, the data stream may be monitored at the computer processing component, the communications interface component, the data resource, or a combination thereof. Monitoring may include keeping track of, and/or storing, the data element, a characteristic or aspect of the data element, metadata relating to the data element (e.g. time of monitoring, source, destination, address, etc.).

In some embodiments, the device includes one or more hardware units each comprising 4 dual core Intel™ Xeon™ processors as the computer processing component; 4 Intel™ 910 PCIe flash cards and twelve 3 Tb mechanical disks as the data storage components; and 41 gbe Network Interface Cards and one or two 10 gbe openflow-enabled switches, as the communications interface. The hardware unit is enclosed in a single 2u supermicro enclosure; in some embodiments the data storage facility comprises one or more hardware units which may present aggregated, scalable, data storage, often as virtual data storage resources. In general, a computing device comprising a CPU, RAM (e.g. 64 mb), and data storage (e.g. disk, SSD, etc.) may be used to carry out some of the embodiments discussed herein. A workload may include the processes that constitute the processing of a virtualized machine or workload thereof (i.e. a workload may be one or more VMs running on the data storage system).

In some embodiments, there is provided a set of instructions recorded on a computer readable medium that, when carried out by a computing device, will provide one or more of the methods disclosed herein. In some embodiments, such a set of instructions may comprise a standalone application that is or can be packaged as an ESX driver or plugin which hooks into a an existing API on a physical or virtual storage device, such as the VMware VSCSI, to obtain request traces of .vmdk files and process them for analysis into or as “counter stacks”. In some cases, the resulting data representations, e.g. counter stacks, can be stored, or communicated to a cloud service or other remote location for analysis and presentation via a web user interface.

In some embodiments, methods of converting the data stream may be further characterized in that the step of determining the current counter value includes storing all data elements in a data stack, and then comparing every new data element in the data stream to the data elements stored in the data stack, and increasing the counter value for each given distinct value counter if that data element has not been previously experienced in the data stream since the beginning of each such distinct value counter. In other words, all count values are stored and each subsequent value is determined by assessing where (or whether) new data elements are present since the beginning of each DVC and, if not, increasing the count value for that DVC by one; otherwise, the count remains the same.

In some methods, the distinct value counter is generated by determining current values at a given time for a given time interval using a probabilistic counter function that determines an estimate of the counter value for each distinct value counter; in some cases, the estimate is within a known range of confidence. In some cases, the probabilistic counter is HyperLogLog, but other probabilistic counters known in the art are possible.

In some embodiments, the number of possible unique distinct value counters (i.e. distinct value counters that have unique starting times) is equal to the number of data elements experienced in the data stream in the estimating time interval; in some embodiments, the number of unique distinct value counters is less than the total number of data elements, including, as non-limiting examples, when a distinct value counter is generated for every 2^{nd}, 3^{rd}, 4^{th}, or n^{th}, data element (respectively generating ½, ⅓, ¼ or 1/n number of unique distinct value counters).

In some embodiments, the interval between sample times and/or start times for DVCs is regular and in some embodiments the interval is irregular. In some embodiments, if two or more unique distinct value counters have the same or similar current values, then the determining and storing steps are not performed for the counter values for some or all of the older distinct value counter in the two or more distinct value counters having the same or similar counter values.

In some embodiments, data stream representations of multiple data streams can be combined to form a combined data stream representation that is indicative of the cardinality of the combined data streams. In some embodiments, the DVC values are added together for all values at the same time in corresponding DVCs for different data streams having the same starting time, thereby producing a further DVC that would have resulted if the data streams had been combined into a single data stream. In other embodiments, the probabilistic counters are calculated for the combined set of data elements at predetermined times. In other embodiments, the probabilistic counters comprise of union functions that can combine existing DVC values that were calculated by way of probabilistic counters; for example, HLL includes a union function, that can be used to combine two DVCs that were generated using HLL into a single DVC that would have resulted from an HLL-determined DVC from combining the data streams into the same aggregated data stream.

In some embodiments, multiple data stream representations can be generated from a single data stream that comprises multiple workloads (wherein a workload is a data stream or a subset of a data stream), wherein a data stream representation is determined for each workload in the data stream. In some embodiments, a data stream representation can be generated by offsetting two or more data streams in time. In some embodiments, multiple data stream representations can be generated for distinct time intervals within a data stream. In some embodiments, the data stream representations are used to determine locality for data elements in the data stream for a data storage facility that can be used to: predict the performance of increasing or decreasing the size or capacity of the memory resource; determine the point at which increasing the size or capacity of the memory resource will have relatively reduced or increased impact on the miss rate (or conversely, the hit rate) of the workload across different sizes of cache; predict the performance from partitioning memory resources for specific workloads and/or data streams; predict the performance of a memory resource when multiple workloads and/or data streams are combined, divided, or staggered (in time); predict the performance of a memory resource when a single workload and/or data stream is split into discrete processing intervals; perform remote or local, real-time or post-facto diagnosis and assessment of data storage performance and activity; identify specific data objects associated with data elements in one or more data streams that are temporally and/or spatially related; and combinations thereof.

In some embodiments, there is provided a data storage facility comprising at least one data storage resource, wherein locality of data elements in a data stream associated with at least one data storage resource therein is determined from a data stream representation, the data stream representation comprising of counter values for each of a plurality of DVCs; wherein in some embodiments an indication of the locality of the data elements is determined by comparing two or more of the plurality of DVCs. In some embodiments, there is disclosed a system for assessing workload characteristics of a data stream relating to data requests for a data storage facility, the data stream comprising a plurality of data elements, the system comprising: a data storage component for storing data relating to the data requests; a computer processing component configured to generate, for at least two sample times, a counter value from each of a plurality of distinct value counters for the data stream, each distinct value counter having a unique start time; the computer processing component further configured to determine the locality of the data elements for at least one of the sample times by comparing the plurality of distinct value counters, wherein said comparison includes determining the differences in count values between adjacent distinct value counters and the times of the occurrence of such differences.

In some embodiments, the computer processing component will be further configured to compare the plurality of distinct value counters by identifying, at a given time, the distinct value counter with the most recent start time that does not increase from a first sample time to a second sample time.

In some embodiments, there is provided a method for converting at least one data stream into a probabilistic representation of the at least one data stream, the representation indicative of a probabilistic locality of data elements of the at least one data stream, the method comprising: For a first data element in a first data stream of the at least one data streams, calculating a probabilistic hash function result at a first sample time; Generating from the probabilistic hash function result, a locality indicative value (i.e. the count of leading zeros in an HLL-based probabilistic counter) and a probabilistic register address; Repeating the calculating and generating steps for at least one other data element at another sample time. In some embodiments, the method for converting at least one data stream into a probabilistic representation further comprises: Generating a probabilistic register for a selected time interval associated with the at least one data streams by placing the locality indicative value associated with the largest sample time that is within the selecting time interval into the probabilistic register at the probabilistic register address; and Calculating a probabilistic counter value from the probabilistic register.

In some embodiments, the method for converting at least one data stream into a combined probabilistic representation further comprises combining sets of a locality indicative value and a probabilistic register address, and the associated sample times, from data streams into the combined probabilistic representation. A hit- or miss-ratio curve, which is often used to assess data workloads on a resource (e.g. a processor or data storage resource), can be generated based on a determination of the locality of data associated with data elements in a data stream.

Locality may be understood as an indication of temporal, spatial and/or temporal-spatial relationship between two or more data elements in a data stream, including the existence or degree of reoccurrence of the same or similar or related unit, and more generally the degree of reoccurrence of data elements and the time/distance therebetween for a data stream overall. Locality may provide an indication of the degree of uniqueness, or lack thereof, for a given data element in a data stream or for the data stream overall or a portion of the data stream. For example, a first and second unit of data in a data stream may have locality with respect to one another if requests to read and/or write data associated with the data units occur close to each other in time. Locality may also include the notion that first and second data units are frequently requested at the same time or closely in time, or that there is a likelihood (empirically, based on past experience, or theoretically, based on a prediction or hypothesis) that such data units will be associated again (i.e. within a data stream or in a series of data units, including data requests) in the future by a closeness in time. A spatial relationship of locality may refer to any or more of a physical relationship on a storage medium, a virtual relationship as being located on the same virtual storage medium, or even an abstract notion of closeness in, for example, an index or a data stack (e.g. having consecutive unique identifiers, irrespective of location on the actual storage medium). For example, if two data units are stored on the same physical data storage resource or near each other on the same data storage resource, they have increased locality with respect to one another. In some cases, storage on the same virtual data storage resource can be associated with an increased locality (irrespective of whether or not the data units, or the data associated therewith, are located on different physical data storage resources which may or may not themselves exhibit a close locality). In some cases, an abstract data construct may be used to describe characteristics of data units or events that have transpired relating to the data units, such as a stack distance table, a stack for LRU (or similar variant of cache replacement techniques), or an index indicative of storage location (such as addresses); closeness in such an abstract manner can be used to characterize an increased locality. As such, stack distance and stack time may be considered to be indicative of locality in some embodiments. In some cases, locality may be assessed with respect to a particular data stream.

In general, a data stream is comprised of a number of distinct data elements. The data elements may comprise of packets, segments, frames, or other protocol data unit, as well as any other units of data, data addresses, data blocks, offsets, pages, or other aspects, descriptors, or portions of data elements. Data elements may include data or identifiers of data. While a data stream typically refers to a continuous stream of discrete elements, a data stream may comprise of a combination of different subsets of data streams which are mixed together in an ordered or unordered manner. In some cases, the subsets may include different workloads, which are sent to or from the same location or over the same network, but exist (for at least at one time) in the same stream of data elements. In some cases, a data stream or portions thereof, may be referred to as a data trace.

In many storage applications, cache memory utilizes one of a few well understood methodologies for populating, and conversely evicting, units relating to data storage in cache memory. One popular page replacement policy for cache memory is the Least Recently Used or LRU policy. LRU models pages in the higher levels of the memory hierarchy with a stack. As pages are referenced by the CPU, the stack model brings them to the top of the stack. Using this model, the page at the bottom of the stack is the least recently used page. When a page is replaced, the LRU algorithm selects this bottom page to remove and puts the new page on the top of the stack. Other variants of LRU include ARC and CAR, which all operate in similar manners by removing the least recently used data units from cache memory, or possibly within a subset of the data. These operate on the assumption that if something has not been used recently, it is less likely to be used again soon. As such, data units in cache become prioritized, possibly in a data abstraction such as a stack, according to the order in which they were last accessed, with the most recent at the top and the least recent at the bottom. The bottom entries in the stack are typically evicted from cache to make room for new entries relating to newly promoted (i.e. recently accessed or written) data units.

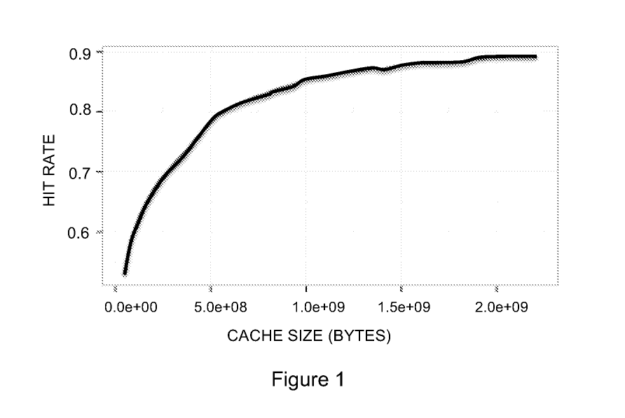

When designing storage hierarchies or analyzing workloads, it is often useful to evaluate the performance of a given page replacement policy. One important tool for evaluating performance is the Hit Rate Curve as shown in FIG. 1. One measure of locality for these methodologies may be referred to as stack distance. Stack distance may be used to build hit-/miss-ratio curves by: (1) determining if an entry has been called before: (2) placing the entry in the stack at the top of the stack and, if called before, removing the entry from its lower position in the stack; and (3) recording the stack distance for that entry as the location in the stack where the entry was found or, if new, infinity. In turn, stack distance is used to build the ratio curve by (i) computing and storing stack distance for all entries in memory; (ii) computing a cumulative distribution function for all entries, except those having infinity; (iii) normalizing across all entries; and (iv) optionally, for a miss-ratio curve, subtracting all entries from 1.

In prior systems, it may have been necessary maintaining a complete data abstraction, or stack, for all data requests hitting the cache. Not to mention, extreme difficulties in computation as such stack grows in size, diversity, and complexity. In some cases, hit rate curves are evaluated using traces, or sequences of page requests generated by a workload. The hit rate curve illustrates what the hit rate (y-axis) of a given trace would be for a cache of given size (x-axis). Hit rates are computed using the set of stack distances derived from a trace. A stack distance calculator maps each page request in a trace to a stack distance. In the case of LRU, a stack distance is defined as the depth into the LRU stack model needed to locate the requested page.

If a given page does not exist in the current stack model, its stack distance is defined to be ∞. The set of stack distances D is stored in a frequency table indexed by size, where D[i] is the number of stack distances equal to i. Given this set of stack distance frequencies D, the hit rate for cache size X is computed as

$${Σ}_{i \leq D [ X ]} \frac{D [ i ]}{Σ D} ,$$

where ΣD is the sum of all the elements of D.

An alternative formulation of stack distance, in some embodiments, can be derived from a set model. For a trace of length T page requests, a set of T sets is maintained, where the i^{th} set at time t is denoted S(i,t). If, for the i^{th} page request, the page is added to the sets S(1,i) through S(i,i), then the set of stack distance frequencies D can be computed with the following update rule for each i, where |·| denotes set cardinality:

D[|S(i,t−1)|]=D[|S(i,t−1)|]+(|S(i+1,t)|−|S(i+t,t−1)|)−S(i,t)|−|S(i,t−1)|)

At each time step, the above update rule will only evaluate to 1 for a single i. The update rule is a difference equation, the discrete analog of a differential equation. It states that the change in the stack distance frequencies is equal to the change in the set membership across sets and across time. The rule evaluates to 1 when there is a set that didn't contain the page at t−1 and now does at t, S(i+1,t)−S(i+1,t−1)=1, is next to a set that already did contain that page, S(i,t)−S(i,t−1)=0. This only happens once because of the inclusion property S(i+1,t)⊂S(i,t).

As an alternative to maintaining stack distance for all data units in a data stream, a data abstraction that maintains cardinality for all units therein provide information relating to, inter alia, whether a given data unit has been seen before in the data stream and how many times. Moreover, if multiple distinct value counters exist for one or more data streams, it becomes possible to determine when a particular data unit may have been accessed previously. In some cases, a perfect understanding of cardinality, and consequently, locality or other stream-related operational characteristics, may not be required and an estimate within a generally understood level of confidence may suffice for analyzing a data stream or the underlying infrastructure. For example, an MRC can be calculated with an increased degree of uncertainty with respect to each count value of the unique DVCs and provide all of the necessary information to make decisions with respect to the effects of increasing or decreasing amounts of storage of a given storage (or alternatively determining whether and/or when a given data storage resource may be experiencing performance issues for a given data stream).

Disclosed herein are various methodologies for generating estimates of distinct value counters, for minimizing the number of counters and size of such counters, and then utilizing the counters in various ways to permit new analyses of workload performance and predictions thereof. Moreover, the counters provide a means for remotely assessing a data stream, and performance associated therewith, for example in a data storage facility, without necessarily having access to an actual data stream. Embodiments include a processor and data storage resources that are configured to receive or have access to a workload; the workload comprising a trace of data requests, the data requests being characterized by a time and in some cases a data unit descriptor.

The distinct value counter, for each new data request in the trace, can be used to determine the stack distance for the data unit associated with the data request, that is, an integer that is equal to the number of unique values that have been received since the beginning of the count.

In some embodiments, a new distinct value counter is started with every data unit in the trace. By comparing each of the distinct value counters, one can determine the time of the last occurrence a specific data unit in the trace, as well as the stack distance of that unit when it was received most recently. For example, when a pair of consecutive entries in a first distinct value counter are the same, and the corresponding entries in the next distinct value counter (that started at the second data unit received in the first distinct value counter) is not also the same as each other, it can be deduced that (i) the stack distance is the value of the pair of repeated entries in the first counter and (ii) the time of the last occurrence of this data unit in the stack was the start time of the first counter. Note that the update rule for stack distances from sets relies only on the cardinality of the individual sets. It is not necessary to retrieve values from the sets, only to calculate how many distance values are contained therein.

Some algorithms and data structures for determining the frequency moments of a data stream have become known in the art. One such moment is the F₀ moment, which estimates the number of distinct values in the stream. It has been shown that very little memory (approximately log N storage) is required to estimate F₀ with reasonable error. The HyperLogLog algorithm is one such distinct value counter that is used in several industrial applications. Much recent work has been devoted to making it space efficient and to reduce estimation bias. As such, it provides a good candidate data structure for the set model of stack distance, S. As such, and in order to avoid having to maintain a distinct value counter across the trace for all trace records, some embodiments will utilize a probabilistic counter. In some cases the probabilistic counter may be the HyperLogLog (HLL) methodology, but other methods known in the art may be used, including but not limited to LogLog, SuperLogLog, FM-85 (see Flajolet & Martin, “Probabilistic Counting Algorithms for Data Base Applications”, JOURNAL OF COMPUTER AND SYSTEM SCIENCES 31, 182-209 (1985), incorporated by reference herein), Probabilistic Counting with Stochastic Averaging, and K-Minimum Values, among others. The HLL is used to estimate cardinality at any given time for a number of unique distinct value counters. This methodology can estimate a cardinality for a workload trace within a predetermined confidence level (c, wherein if T is the true cardinality value then the estimated value, E, will be E within (1±ε)T). In some embodiments, the probabilistic counter may be used to calculate the values of one or more distinct value counters, wherein the one or more distinct value counters can have distinct starting points. In embodiments, the distinct value counters can be characterized as a determination or an estimation (since some embodiments may use a probabilistic counter to estimate values) the 0th frequency moment of a data stream at one or more times and/or for one or more time intervals.

Some probability counters, including HLL, also provide for a number of additional functions that permit further analysis. These include the following:
Update: This function will update the register of locality indicative values (i.e. leading 0's for a given hash function applied to data elements in accordance with the HLL).
Estimate: Provides a new calculation of the distinct value count for a given data stream or portion thereof based on the current state of the register of locality indicative values.
Union: This function permits the union of two or more separate workloads to be combined and therefore calculate distinct value counters for the combined set of data streams (i.e. as if they had been combined as one data stream) and locality for data elements in what would be the combined data stream.
Intersect: This function permits a calculation of the estimated count of data elements that are common to two or more data stream.

In order to process the trace and output the Counter Stack matrix in some embodiments, a sequence of counters is maintained, each of which reports the number of distinct elements it has seen. To compute the number of distinct elements exactly would require a dictionary data structure, which takes linear space. The number of distinct elements in the trace, M, can be quite large, so this approach can become prohibitive as the trace becomes large. Bloom filters can be used to reduce the space somewhat, but for an acceptable error tolerance, they could still be prohibitively large for some sizes of data traces. In some embodiments, probabilistic counters may be used; the probabilistic counters may be associated with low space requirements and improved accuracy. One version of these is the HyperLogLog counter, or HLL, which may be used in some embodiments. The space required by each HLL counter is roughly logarithmic in N and M, for data streams of N data elements with M unique elements.

Counter stack streams may contain the number of distinct blocks seen in the trace between any two points in time (i.e. a complete counter for every distinct data element). The on-disk stream only needs to store this matrix of counts. However, in some embodiments the in-memory counter stack is also able to update these counts while processing the trace, so each counter must keep an internal representation of the set of blocks it has seen. The most accurate, but space and processing power limiting, approach is for each counter to represent this set explicitly, but this would require quadratic memory usage (assuming there is no downsampling or pruning). A slight improvement can be obtained through the use of Bloom filters, but for an acceptable error tolerance, the space could be large for some data streams. A probabilistic counter or cardinality estimator reduces the need to explicitly record entire blocks of counts for each stream element. Each count appearing in an on-disk stream is not the true count of distinct blocks, but rather an estimate produced by a HyperLogLog counter (or other probabilistic counter) which is correct up to multiplicative factor of 1+ε. The memory usage of each HyperLogLog counter is roughly logarithmic in M, with more accurate counters requiring more space. More concretely, the traces from the Microsoft Research collection (the MSR trace), containing over a hundred million requests and hundreds of millions of blocks, used as little as 53 MB of memory to process.

Also, there are provided herein methodologies utilizing binning to compress the amount of distinct value counters. This may impact the accuracy of the results, since it results in providing a range of what cardinality (or HLL calculation thereof, and itself an estimation) but can be maintained well within an acceptable error to generate the necessary performance statistics, even with significant compression. Binning is the removal of certain counters and/or reducing the collection times to less than for each element of each trace. Through the use of binning, calculating and storing count values for each DVC need not occur at every time interval (or at every data element). For example, with reference to FIG. 2, a determination of the DVC at t=0, 2, 4, etc. can be made where the samples in the intervening intervals are not taken; in FIG. 2, the grey columns indicate the sample times at which a counter value is determined. This may further impact the precision of the locality, since it is no longer possible to know whether a DVC counter increased at the sample time or at some point between the current sample and the previous sample, such reduction in precision is generally not limiting when determining locality or performing other characteristic analyses, such as a the creation of an MRC for a given workload on a given data storage resource. As the size of the data stream approaches, for example, billions of data elements in a given time interval, this uncertainty will generally not impact the overall analysis in any material way. Binning may also refer to reducing the number of unique DVCs that are determined and stored. For example, with reference again to FIG. 2, a new DVC may be started only at every second data element in the data stream, as shown by the grey rows. As with the sample-reduction binning, there is an impact, though not a material one depending on the size of the data stream and the reduction in DVC counters, on the precision of the locality determination. Without binning, the determination of a stack distance locality for an LRU-based data storage device would be determined as being equal to the value of the newest DVC to not increase from one interval to the next. With binning, stack distance is a value within the following range: between (value of DCV_{BIN1} at t=x) and (value of DVC_{BIN1} at t=x+1), where DVC_{BIN1} is the newest DVC not to have increased as much as possible during the interval between bins. For example, with reference to FIG. 2, if only every second possible DVC is being collected (e.g. DVC₁, DVC₃, DVC₅, etc., are being collected at every sample time interval (indicated by the grey rows and columns and intersections thereof), it shows that a non-distinct value was encountered in the data stream at t=4 as DVC₁ did not increase by the number of data elements in the data stream during the interval. Since DVC₃ did increase by that amount, then it can be determined that the data element at one of t=3 or t=4 was a non-distinct value and the stack distance was either 3 or 4 (since the value of DVC₁ at t=4 is 4 but is unknown whether the increase from a value of 3 occurred from t=2 to t=3 or from t=3 to t=4); it can also be determined that the time between sampling distinct values either 3 or 4 sample times, since it is known that DVC₁ started at t=0 and increased at either t=3 of t=4.

Using this same methodology, a range of upper and lower possible stack distances and stack times can be determined within a specific confidence range. As the number of data elements, and thus samples increase, the effect of this uncertainty is reduced; in some cases, it can be assumed that the uncertainty is distributed normally across the size of each of the bins and therefore should not impact the final result as the sample size grows. It is not necessary that combined data streams, or representations thereof, have equal bins (e.g. sample times and number of unique DVCs); such data sets can nevertheless be combined using the methodologies provided herein.

Another technique for reducing the amount of data that is collected is referred to as pruning. The concept of pruning is based on the assumption that once two adjacent counters are equal, or close to being equal, they will continue to be equal thereafter. As such, there is no need to perform additional calculation or store in memory, any older counters that have become equal to newer counters. In some embodiments, the DVC values of any older adjacent calculated DVC (in the case of binning, not all possible DVC will be collected in any event) that is equal or nearly equal will be dropped. By way of example, if the difference between adjacent calculated DVCs is less than a given value (which may in some embodiments be a function of the amount of binning of DVCs and in other cases may be predetermined value or factor), then the older adjacent calculated DVC can be dropped from the analysis and additional count values therefor need not be stored in memory.

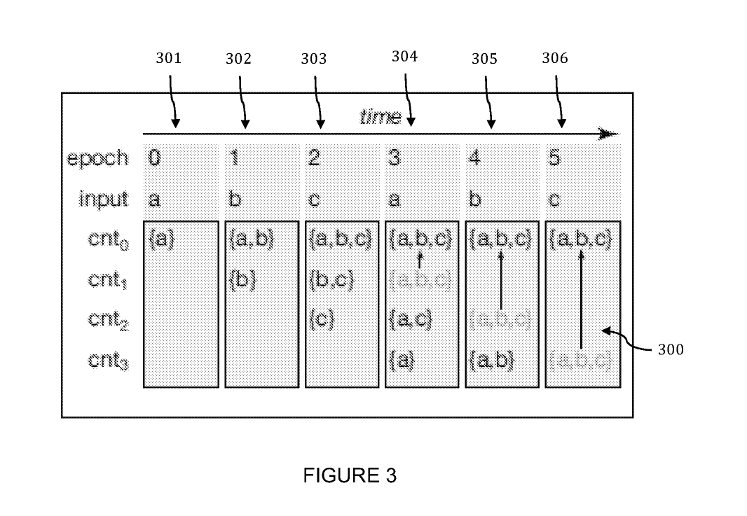

With reference to FIG. 3, Counter stacks 300 are shown over a given time interval. Columns 301 to 306 show counter stack state at each epoch. Newer counters are pruned as their contents become redundant. In the instance shown, the count values for newer counters are not collected and are assumed to be those of the oldest counter with values that are the same, or have difference from such oldest counter values that is less than p.

With further reference to binning and pruning, it may become in some cases unfeasible to create and maintain a DVC per time step, as the number of data elements in the data stream, T, is potentially in the billions. Rather, it is provided for herein to reduce the number of counters by vastly increasing the number of time steps between their creation. By increasing the time steps between creating counters the interval in which a stack distance may come from is also increased, the update rule then becomes:

D[|S(i+1,t−1)|,|S(i,t)|]=D[|S(i+1,t−1)|,|S(i,t)|]+(|S(i+1,t)|−|S(i+t,t−1)|)−(|S(i,t)|−|S(i,t−1)|)

Note that instead of adding the change in sets to a single bin in the stack distance frequency set D, it is added to an interval |S(i+1,t−1)|,|S(i,t)|. If this interval intersects multiple bins, then the proportion of the interval contained in a given bin is added to that frequency bin. This assumes a uniform distribution of stack distances across estimated intervals. But even with coarse spacing, there may be far too many counters to update efficiently for some applications. In practice it would be better to be able to bound the number of counters. It is possible to bound the counters by pruning them when they get close in their distinct values. Any counter that does not have a sufficiently large interval between its next and previous counters may be removed. This ensures there will be no more counters than L/p, where L is the count of the largest counter and p is the pruning interval. In one embodiment, the MRC is determined as follows: (i) Define pruning interval p and creation interval c; (ii) Iterate the following steps over the entire trace: (ii.1) Read in c pages; (ii.2) Update all counters in parallel; (ii.3) Calculate update rule and update stack distances, D; and (ii.4) Prune counters; and (iii) Create a new counter Output Hit Rate Curve from D.

Stack distances and MRCs have numerous applications in cache sizing, memory partitioning between processes or VMs, garbage collection frequency, program analysis, workload phase detection, etc. A significant obstacle to the widespread use of MRCs is the cost of computing them, particularly the high storage cost. Existing methods require linear space. Counter stacks (or other data representations of a data stream indicative of locality) eliminate this obstacle by providing extremely efficient MRC computation while using sublinear space. In some embodiments, stack distances, and hence MRCs, can be derived from, and/or idealized, by counter stacks. In some cases, stack distance of a given request is the number of distinct elements observed since the last reference to the requested element. Because a counter stack stores information about distinct elements, determining the stack distance is straightforward. At time step j one must find the last position in the trace, i, of the requested element, then examine entry C_{i,j} of the matrix to determine the number of distinct elements requested between times i and j. For example, consider the following matrix, hereinafter referred to as C:

$$( \underline{\begin{matrix}a , & b , & c , & a , & b , & c\end{matrix}} )$$

$$\begin{matrix} 1 & 2 & 3 & 3 & 3 & 3 \\ & 1 & 2 & 3 & 3 & 3 \\ & & 1 & 2 & 3 & 3 \\ & & & 1 & 2 & 3 \\ & & & & 1 & 2 \\ & & & & & 1\end{matrix}$$

To determine the stack distance for the second reference to trace element a at position 4, whose previous reference was at position 1, look up the value C_{1,4} and get a stack distance of 3. The last position in the trace of the requested element is implicitly contained in the counter stack, as follows: suppose that the counter that was instantiated at time i does not increase during the processing of element eⱼ. Since this counter reports the number of distinct elements that it has seen, it can be inferred that this counter has already seen element eⱼ. On the other hand, if the counter instantiated at time i+1 does increase while processing eⱼ, then it can be inferred that this counter has not yet seen element eⱼ. Combining those inferences, it can be further inferred that i is the position of last reference. These observations lead to a finite-differencing scheme that can pinpoint the positions of last reference. At each time step, it can be determined how much each counter increases during the processing of the current element of the trace. This is called the intra-counter change, and it may be defined to be:

Δxᵢⱼ=C_{i,j}−C_{i,j-1}

To pinpoint the position of last reference, the newest counter that does not increase is identified. This can be done by comparing the intra-counter change of adjacent counters. This difference is called the inter-counter change, and may be defined as:

$${y}_{ij} = \{ \begin{matrix}Δ {x}_{i + 1 , j} - Δ {x}_{i , j} & if i < j \\ 0 & if i = j\end{matrix}$$

Restricting to the first four elements of C (shown above), the following matrices may be observed:

$$\begin{matrix}\begin{matrix}\underline{( \begin{matrix}a , & b , & c , & a ,\end{matrix} )} \\ \begin{matrix}1 & 1 & 1 & 0 \\ & 1 & 1 & 1 \\ & & 1 & 1 \\ & & & 1\end{matrix}\end{matrix} \\ Δ x\end{matrix} \begin{matrix}\begin{matrix}\underline{( \begin{matrix}a , & b , & c , & a ,\end{matrix} )} \\ \begin{matrix}0 & 0 & 0 & 1 \\ & 0 & 0 & 0 \\ & & 0 & 0 \\ & & & 0\end{matrix}\end{matrix} \\ Δ y\end{matrix}$$

Every column of Δy either contains only zeros, or contains a single 1. The former case occurs when the element requested in this column has never been requested before. In the latter case, if the single 1 appears in row i, then last request for that element was at time i. For example, because Δ_{1,4}=1, the last request for element a before time 4 was at time 1. Determining the stack distance is now simple, as before. While processing the trace at time j (i.e., column j of stream), it can be inferred that the last request for the element eⱼ occurred at time i by observing that yᵢⱼ=1. The stack distance for the j^{th} request is the number of distinct elements that were requested between time i and time j, which is Cᵢⱼ. Another way to determine the MRC at cache size x is to identify the fraction of requests with stack distance at most x. Therefore given all the stack distances, the MRC may be computed.

In some embodiments, computing stack distances and MRCs using idealized counter stacks can be adapted to use practical counter stacks. For example, the matrices Δx and Δy are defined as before, but are now based on the downsampled (i.e. sliced), pruned matrix containing probabilistic counts. With a complete set of counters, with counts at every element, every column of Δy is either all zeros or contains a single 1. With downsampling and pruning, this is not necessarily the case. The entry Δyᵢⱼ now reports the number of requests since the counters were last updated whose stack distance was approximately Cᵢⱼ. To approximate the stack distances of all requests, one may process all columns of the stream. As there may be many non-zero entries in the j^{th} column of Δy, one may record Δyᵢⱼ occurrences of stack distance Cᵢⱼ for every i. As before, given all stack distances, one can compute the MRC. An online version of this approach which does not emit streams can produce an MRC of predictable accuracy using provably sublinear memory. Empirical analysis has shown that the online algorithm produces an estimated MRC that is correct to within additive error ε at cache sizes

$$\frac{1}{𝓁} M , \frac{2}{𝓁} M , \frac{3}{𝓁} M , … , M$$

using only O(l³ log 2 (N)/ε³) bits of space, with high probability. It has been observed in empirical analyses, that the space depends polynomially on l and ε, the parameters controlling the precision of the MRC, but only logarithmically on N, the length of the trace.

The idealized counter stack stream may store the entire matrix C, so it requires space that is quadratic in the length of the trace. This is actually more costly than storing the original trace. There is provided herein the ability to coarsening the time granularity, i.e., increasing the time interval magnitude between counts and keeping only every d^{th} row and column of the matrix C. There is also provided the concept of pruning: eventually a counter may have observed the same set of elements as its adjacent counter, at which point maintaining both of them becomes unnecessary. In addition, the crucial idea of using probabilistic counters to efficiently and compactly estimate the number of distinct elements seen in the trace is provided.

By generating a plurality of values for distinct value counters associated with a given data stream, a number of additional functionalities become possible. One of these additional functionalities includes combining two or more distinct data streams; in some cases, the data streams may comprise non-disjoint sets such as reads and writes to the same data storage resource. By utilizing the techniques provided for herein, DVCs can be combined; in some embodiments, for example, the probabilistic function union can be used to determine the DVC for what the combined data stream would produce. As such, it becomes possible to analyze what would happen if two workloads were combined, and conversely, what would happened if two or more combined workloads were isolated or offset in time from each other. In some techniques in accordance with another embodiment, there is provided a method for working with independent counter stacks to estimate miss ratio curves for new workload combinations.

In some embodiments, there is functionality to implement slice, shift, and join operations, enabling the nearly-instantaneous computation of MRCs for arbitrary workload combinations over arbitrary windows in time. These capabilities extend the functionality of MRC analysis in many ways and can provide valuable insight into live workloads, as have been demonstrated with a number of case studies. An offset in time can be referred to as a time shift; by offsetting the sample of times it becomes possible to analyze what would happen if two or more distinct workloads, which may have been processed on a given data storage resource concurrently or even separately, were combined but with a time offset between the start times for each workload. An isolation of parts of a single or combined workload can be referred to as a time slice; by splitting the workload, the effect on locality and also, for example, the MRC for that workload on a particular data storage device can be assessed. It does not matter whether such workload is the result of a combined, offset, or single data stream. As such, one can analyze what would happen if portions of a workload were isolated and were run as independent workloads.

One way to improve the space used by counter stacks and streams is to coarsen the time granularity (which may be understood as in some embodiments as decreasing the time resolution, or downsampling, or slicing). Coarsening the time granularity amounts to keeping only a small submatrix of C that provides enough data, and of sufficient accuracy, to be useful for applications. For example, one could start a new counter only at every d^{th} position in the trace; this amounts to keeping only every d^{th} row of the matrix C. Next, one could update the counters only at every d^{th} position in the trace; this amounts to keeping only every d^{th} column of the matrix C. The resulting matrix may be called the coarsened or downsampled matrix. Adjacent entries in the original matrix C can differ only by 1, so adjacent entries in the coarsened matrix can differ only by d. Thus, any entry that is missing from the coarsened matrix can be estimated using nearby entries that are present, up to additive error d. For large-scale workloads with billions of distinct elements, even choosing a very large value of d has negligible impact on the estimated stack distances and MRCs. In some implementations, there is provided a more elaborate form of coarsening that combines traces that potentially have activity bursts in disjoint time intervals. In addition to starting a new counter and updating the old counters after every d^{th} request, a new counter is started and the old counters are updated every s seconds.

In some cases, every row of the matrix contains a sequence of values reported by some counter. For any two adjacent counters, the older one (i.e., the higher row) will always emit values larger than or equal to the younger one (i.e., the lower row). Initially, at the time the younger one is created, their difference is simply the number of distinct elements seen by the older counter since that older counter started. If any of these elements reappears in the trace, the older counter will not increase (as it has seen this element before), but the younger counter will increase, so the difference of the counters shrinks. If at some point the younger counter has seen every element seen by the older counter, then their difference becomes zero and will remain zero forever. In this case, the younger counter provides no additional information, so it can be deleted, or not used to collect information, or not stored in memory. An extension of this idea is that, when the difference between the counters becomes sufficiently small, the younger counter provides negligible additional information. In this case, the younger counter can again be deleted, and its value can be approximated by referring to the older counter. This process may be referred to herein as pruning. The simplest pruning strategy is to delete the younger counter whenever its value differs from its older neighbour by at most p, where p is a predetermined or calculated value. This strategy ensures that the number of active counters at any point in time is at most M/p, where M is the number of distinct blocks in the entire trace. In some implementations, in order to fix a set of parameters that work well across many workloads of varying sizes, the younger counter may be deleted whenever its value is at least (1−δ) times the older counter's value. This ensures that the number of active counters is at most O(log(M)/δ). In some embodiments, δ∈{0.1,0.01}, but other sets of δ are possible.

It is often useful to analyze only a subset of a given trace within to a specific time interval; such analysis of a subset of a data stream may be referred to as time based selection, or Time Slicing or slicing. It is similarly useful when joining traces to alter the time signature of by a constant time interval; such alteration may be referred to as Time Shifting or shifting. Counter stacks support Time Slicing and Shifting as indexing operations. Given the Counter Stack C, the Counter Stack for the time slice between time i and j is the submatrix with corners at Cii and Cjj. Likewise, to yield the Counter Stack for the trace shifted forward/backward s time units, s is added/subtracted to each of the time indices of the counters in the Counter Stack.

Given two or more workloads, it is useful to measure the effects of combining the workloads into a single trace. In practice, this implies creating a new trace by merging the elements of their respective traces in time order. Consider the following merge of the two traces A={a; b; b} and B={d; d} and their merge A+B:

| time | 1 | 2 | 3 | 4 | 5 |
|---|---|---|---|---|---|
| A | a | | b | | b |
| B | | d | | d | |
| A + B | a | d | b | b | b |

One of the benefits of the Counter Stack representation of a trace is that instead of needing to sort the two traces in time order and then compute the Counter Stack of the merged trace, one can simply add the Counter Stacks together. In order to keep addition of Counter Stacks consistent, counter values may be inferred where none are recorded. For example, trace B doesn't have a counter starting at time 1, but the value of what a counter started at time 1 would be needs to be inferred or otherwise calculated in order to add B with A. In the event that a Counter Stack fails to store a matrix row for a given time t, the nearest row satisfying t′>t is selected. This constraint is to prevent choosing a counter with starting time earlier than t, which will include the counts of elements in the stream prior to t. If no such time exists, then a row of all zeros is selected. Likewise, in the event of a missing column for a given time t, the nearest row t″<t is selected, returning a zero element if no such time exists. This constraint prevents choosing the state of a counter subsequent to t, which would include the counts of any elements in the stream after t.

The following table shows the Counter Stacks for traces A and B and their sum A+B. Inferred values are highlighted in bold, which are unnecessary to compute or store.

| time | 1 | 2 | 3 | 4 | 5 |
|---|---|---|---|---|---|
| A | a | | b | | b |
| C_{A} | 1 | 1 | 2 | 2 | 2 |
| | | 0 | 1 | 1 | 1 |
| | | | 1 | 1 | 1 |
| | | | | 0 | 1 |
| | | | | | 1 |
| B | | d | | d | |
| C_{B} | 0 | 1 | 1 | 1 | 1 |
| | | 1 | 1 | 1 | 1 |
| | | | 0 | 1 | 1 |
| | | | | 1 | 1 |
| | | | | | 1 |
| A + B | a | d | b | d | b |
| C_{A + B} | 1 | 2 | 3 | 3 | 3 |
| | | 1 | 2 | 2 | 2 |
| | | | 1 | 2 | 2 |
| | | | | 1 | 2 |
| | | | | | 1 |

Counter Stack rows form cumulative sum tables of unique requests given a start position in the trace. Given these tables, one can answer queries about the number of requests in a given trace interval, as well as the number of unique requests in said interval. To count the raw number of requests between to positions i and j, compute C_{Rj}−C_{Ri}. To count the number of unique requests between to positions i and j, compute Cij. Furthermore, to count the number of unique trace requests between i and j with respect to a warm-up period from w to i, compute C_{wj}−C_{wi}.

There is provided in embodiments, or aspects thereof, a non-transitory computer-readable memory with instructions thereon that provide for a Counter Stack API which may be used to compute counter stacks and operations disclosed herein. The Counter Stack finite differencing scheme for matrix C is shown above as a sequence of full matrix operations. For each iteration in practice, however, one need only keep the two adjacent columns of each Counter Stack in memory to compute the stack distances or trace request numbers. Some embodiments exploit this by operating on Counter Stacks using a streaming model, wherein the full stacks are not stored in memory. Instead, compressed columns of each of the Counter Stacks are streamed from disk, computing and storing accumulated stack distances in a histogram table for output. This means that one can the compute any MRC from a set of stored Counter Stacks while only allocating enough memory to hold two counter stack columns per stack and a histogram, often needing only a few megabytes of memory.

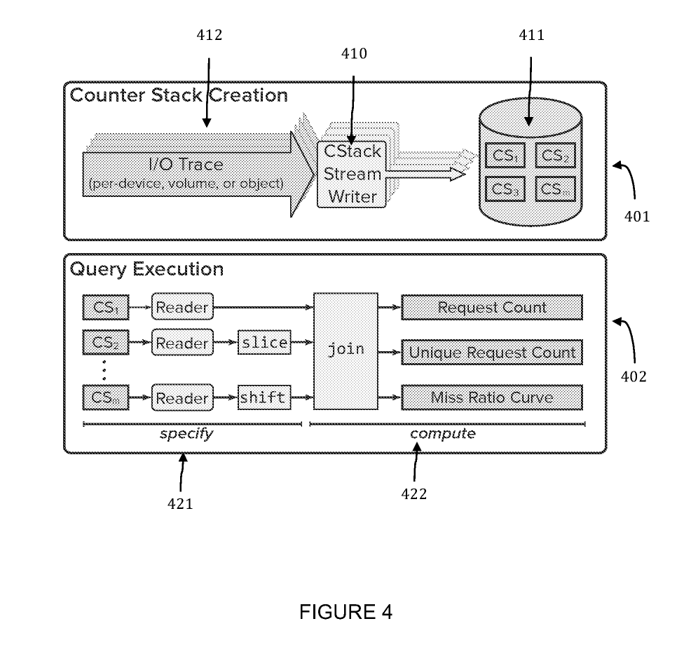

There is shown in FIG. 4, a summary of a two-part architecture of an API in accordance with one embodiment. The top portion 401 illustrates the components used to create and update the Counter Stacks on disk. The bottom portion 402 shows the components used to execute Counter Stack queries on a system's Counter Stack database. Counter Stack creation is handled by the Counter Stack Stream writer 410. The Stream Writer 410 maintains a set of counters and stream metadata 411 for each I/O input trace 412. After each trace request, the Stream Writer 401 updates the counters assigned to the trace. When a stack output event occurs, whether from a certain number of trace requests occurring or time period elapsing, the Counter Stack Stream Writer 401 appends a new column to trace the associated Counter Stack on disk. It then performs the internal counter pruning and creation for the same Counter Stack.

The Counter Stack query execution 402 is divided into two parts: query specification 421 and query computation 422. In the specify half of query execution 421, a subset of Counter Stacks are chosen from the database of available Counter Stacks, then each Counter Stack is optionally sliced by a user-determined time interval and then shifted forward or backward in time by a time offset. In the compute half of query execution 422, the set of specified Counter Stacks are first merged together with the Join operation and then the joined Counter Stacks are streamed to different query operations like MRC, Unique Request Count, and raw Request Count calculation.

The system represented by the architecture shown in FIG. 4 may be considered as a flexible, memory-efficient library that can be used to process traces, produce counter stack streams, and perform queries on those streams. The workflow of applications that use this library is illustrated in FIG. 4.

In some embodiments, on-disk streams outputs by the library architecture in FIG. 4, which may be referred to herein as the counter stack library, are produced by periodically outputting a new column of the matrix. A new column may be produced if either d requests have been observed in the trace or s seconds have elapsed (in the trace's time) since the last column was produced. Each column may be written to disk in a sparse format, to incorporate the fact that pruning may cause numerous entries to be missing. In addition, the on-disk matrix C includes an extra row, called row R, which records the raw number of requests observed in the stream. That is, C_{Rj} contains the total number of requests processed at the time that the j^{th} column is output. Finally, the on-disk stream also records the trace's time of the current request. The counter stack library supports three computational queries on streams: Request Count, Unique Request Count and MRC (other libraries may be used separately or in combination with this library which comprise additional functionalities for other types of analyses, including but not limited to histograms, CDFs, and other analyses relating to stack time, stack distance, cardinality or locality). The Request Count query simply asks for the total number of requests that occur in the stream, which is C_{Rj} where j is the index of the last column. The Unique Request Count query is similar except that it asks for the total number of unique requests, which is C₁ⱼ. Another stream operation is the MRC query, which asks for the miss ratio curve of the given stream, as described above.

The counter stack library also supports slicing and shifting as specification operations. Given a stream containing a matrix C, the stream for the time slice between time step i and j is the submatrix with corners at Cᵢᵢ and Cⱼⱼ. Likewise, to obtain the stream for the trace shifted forward/backward s time units, one may add/subtract s to each of the time indices associated with the rows and columns of the matrix.

Given two or more workloads, it is often useful to understand the behavior that would result if they were combined into a single workload. For example, if each workload is an I/O trace of a different process, one may be interested to understand the cache performance of those processes with a shared LRU cache. Counter stacks enable such analyses through the join operation. Given two counter stack streams, the desired output of the join operation is what one would obtain by merging the original two traces according to the traces' times, then producing a new counter stack stream from that merged trace. The counter stack library can produce this new stream using only the two given counter stacks, without examining the original traces. It may be assumed that the two streams must access disjoint sets of blocks. The join process would be simple if, for every i, the time of the i^{th} request were the same in both traces; in this case, the matrices stored in the two streams are added together. Unfortunately that assumption is implausible, so more effort is required. The main ideas are to:
Expand the two matrices so that each has a row and column for every time that appears in either trace.
Interpolate to fill in the new matrix entries.
Add the resulting matrices together.

The following example provides another example. Consider a trace A that requests blocks (a,b,b) at times 1:00, 1:05, 1:17, and a trace B requests blocks (d,d) at times 1:02 and 1:14. The merge of the two traces is as follows:

| time | 1:00 | 1:02 | 1:05 | 1:14 | 1:17 |
|---|---|---|---|---|---|
| A | a | | b | | b |
| B | | d | | d | |
| merge | a | d | b | d | b |

To join these streams, the matrices in the two streams are expanded so that each has five rows and columns, corresponding to the five times that appear in the traces. After this expansion, each matrix is missing entries corresponding to times that were missing in its trace. The missing entries are provided by an interpolation process: a missing row is filled by copying the nearest row beneath it, and a missing column is filled by copying the nearest column to the left of it. The following table shows the resulting matrices, including the joined or merged matrices from adding the original two matrices together; interpolated values are shown in bold:

| time | 1:00 | 1:02 | 1:05 | 1:14 | 1:17 |
|---|---|---|---|---|---|
| A | a | | b | | b |
| C_{A} | 1 | 1 | 2 | 2 | 2 |
| | | 0 | 1 | 1 | 1 |
| | | | 1 | 1 | 1 |
| | | | | 0 | 1 |
| | | | | | 1 |
| B | | d | | d | |
| C_{B} | 0 | 1 | 1 | 1 | 1 |
| | | 1 | 1 | 1 | 1 |
| | | | 0 | 1 | 1 |
| | | | | 1 | 1 |
| | | | | | 0 |
| merge | a | d | b | d | b |
| C_{A} + C_{B} | 1 | 2 | 3 | 3 | 3 |
| | | 1 | 2 | 2 | 2 |
| | | | 1 | 2 | 2 |
| | | | | 1 | 2 |
| | | | | | 1 |

While a number of the optimizations described herein dramatically reduce the storage requirements of Counter Stacks, they may also introduce uncertainty and error into the final calculations. Probabilistic Counters used in some embodiments introduce error in two ways: estimation error and amortized updates. Estimation error is the error introduced by the error in the probabilistic counter estimate. The final estimated number of unique elements observed is only correct up to a multiplicative factors, determined by the precision of the HyperLogLog counter. Estimation error is manifested by deviation from the true MRC and can be controlled by increasing the precision of the HyperLogLog counters. Amortized updates are a subtler form of error that is introduced by the update schedule of the HyperLogLog counters. In perfect distinct value counters, the observation of a new element will increase the counter by one, but this does not necessarily hold for HyperLogLog counters. Instead, a HyperLogLog counter may require observing U new unique items before increasing in value by U, where U is a random variable proportional to the precision of the counter. The staggered, amortized update schedule of different counters can introduce negative numbers of stack distances under finite differencing schemes, and result in small fluctuations of the normally monotonic MRC.

In perfect counters, the observation of a new element will increase the counter by 1. Instead, a HyperLogLog counter may remain static after seeing k new elements, only to increase its count by k after seeing one more element. After performing the finite differences operation shown above, the Δy matrix may thus contain negative entries, which will produce a non-monotonic MRC. Whereas the finite-differences scheme that uses an exact (i.e. Non-probabilistic) counting methodology, with data collection and counter calculation at every data element, computes stack distances exactly, the modified scheme using probabilistic counters, pruning, binning (and other compression techniques) only computes approximations. This uncertainty in the stack distances is often caused by downsampling, pruning and use of probabilistic counters. To illustrate this, consider the following, and for illustration only in this example, pruning and any probabilistic errors will be ignored. At every time step j, the finite differencing scheme uses the matrix Δy to help estimate the stack distances for all requests that occurred since time step j−1. More concretely, if such a request increases the (i+1)^{th} counter but does not increase the i^{th} counter, then it follows that the most recent occurrence of the requested block lies somewhere between time step i and time step i+1. Since there may have been many requests between time i and time i+1, there is insufficient enough information to determine the stack distance exactly, but it can be estimated it up to additive error d (the downsampling factor). A careful analysis can show that the request must have stack distance at least Ci+1,j−1+1 and at most Cij.

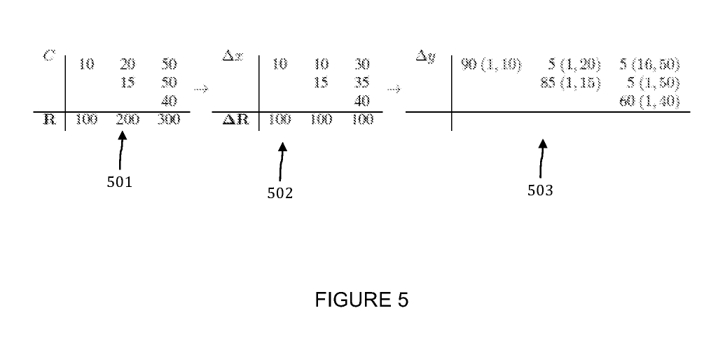

For coarsened (i.e. binned), pruned Counter Stacks, the finite differencing scheme described herein suffices to compute the count of references between two trace positions, modulo the error discussed above. In more detail, the nonzero entries Δyᵢⱼ count the number of references between time j−k and j with last positions between i and i+k. Because the counters between i and i+k, as well as the counter state between j−k and j, are elided, one can no longer resolve these references to a single stack distance. However, the stack distances can be bound to an accuracy determined by the coarsening factor k. Computing the bounds of the uncertainty of the stack distances is then done with two table lookups, instead of the single lookup in the full Counter Stack case. The upper bound of the range is the number of unique references observed since the earliest position i at the newest time j, or Cᵢⱼ. The upper bound on the stack distances may be referred to as the pessimistic bound. In contrast, the optimistic bound is the smallest possible stack distance, or one more than the number of unique observations observed since the more recent position i+k at the earlier time j−k. It is computed by looking up the value C_{i+k;j-k}+1. If the counter i+k does not exist at position j−k, then the lower bound is 1 because Cᵢⱼ=0. With reference to FIG. 5, an illustration of this uncertainty on a small coarsened Counter Stack is shown. Computing stack distances on the coarsened Counter Stack C 501 introduces uncertainty in the final values of the stack distances in the Δy 503 on the right. The interval to the right of the count of stream references in Δy 503 shows the (lower, upper) bounds of the distance estimates for those references. The Δx 502 shows the magnitude of the time interval as well as the increase in the count values for distinct value counters.

It is also provided herein to provide a means of determining an estimation of working set size. By using the relationship between distinct value and the number of unique elements in a working set, the total size of the working set can be estimated, particularly when using pruning methodologies. By determining the distribution of the size of DVC counters prior to pruning, since a highly repetitive set of data elements will result in relatively quick pruning of older DVCs, the size of the overall working set can be estimated. Through the use of intersections analysis between data stream representations, an assessment of the number of common data elements between data streams. In addition to understanding whether there may be efficiencies gained in combining resources for such data streams, it also becomes possible to consider prefetching certain information onto higher performing data storage tiers. For example, intersections over time can identify an increase in non-unique access patterns at periodic or predictable times. By determining whether there are common group of addresses (or other data elements or aspects thereof) from the data streams at these predictable times, the data associated with those intersecting data elements can be promoted to higher performing data storage resources. Conversely, the data can be pre-demoted between such periodic or predictable times so as to increase capacity on the higher performing data resources for other data. Since the data stream can be converted into a representation, and possibly compressed, it becomes possible to assess all of the above functionalities without having access to the data stream or the data storage resources. The representations can be stored and analysed later and/or they can be analyzed remotely. Further, they can be analyzed in real time, locally or otherwise. Proactive troubleshooting and remote management therefore becomes possible, even without access to the data storage or processing facility or the data stream itself. There is provided the ability to diagnose issues relating to data storage systems by reviewing the plurality of distinct value counters, or the probabilistic counter compressions to determine when performance becomes impacted without access to the data stream (or trace thereof) or data storage system.

Embodiments provided herein leverage the HLL to compress information relating to a data stream to, inter alia, generate distinct value counters efficiently and store data to generate HLL registers that can be used to recreate distinct value counters in any time interval during the trace. In general, HLL operates on the premise that very small numbers within a data set are unlikely. It utilizes a hash function to normalize a distribution, wherein the same number will result in the same hashed result. Based on the observation that a number resulting in a hashed result in a binary format becomes smaller as the number of leading zeros increases, and that a binary number with a particular number of leading zeros is half as likely to occur in certain distributions as a number with one fewer leading zeros, the HLL uses the number of leading zeros in the hashed result to estimate, or act as a proxy for, the likelihood of a given data element in a data stream. The HLL captures a number of hashed results into an HLL register and then combines a number of estimates, using a mathematical formula (as described more fully in Flajolet et al., “HyperLogLog: the analysis of a near-optimal cardinality estimation algorithm” 2007 Conference on Analysis of Algorithms, DMTCS proc. AH, 2007, 127-146; incorporated herein by reference) to reduce the likelihood of an outlier, or “unlucky” estimate (e.g. capturing an extremely unlikely element early within a sample interval). The combination of a number of estimates, in addition to other functions, serves to reduce the effect of coincidence and thus the larger the number of samples in an HLL register, the closer HLL will approach the true cardinality for a given value.

HLL uses leading zeros in the hashed result as a proxy for smallness of the hashed result; HLL assumes that a small hashed result is unlikely, and then uses a mathematical operation (such as a weighted average to combine a number of several hashed results), thereby reducing the effects of outliers and/or “unluckiness”, to provide an estimate of cardinality for a given data element in a given data stream. The number of samples in the weighted average is related to the accuracy of the estimate; an increase in the number of samples increases the accuracy.

Some embodiments for converting a data stream into a representation of locality may utilize the HLL methodologies and aspects thereof. The HLL retains a register of values, wherein each location in the register is uniquely associated with each possible data element in the data stream and each register value being populated with a value that is indicative of the a probability of the data element having been experienced previously; this value may be referred to as the locality indicative value. In some embodiments, a pseudo-HLL register is maintained wherein an abstract data construct is generated as a 2-dimensional data structure, comprising of n columns and p rows, wherein n is the number of possible HLL register values and p is a number relating to the probability of the data element having been experienced in the data stream, which is the locality indicative value (in this embodiment, the locality indicative value is the number of leading zeros in the hash function result), and within each entry of the data structure is the time of the observation a data element with a matching register number and leading zero count; the register state of an HLL register can then be generated from the pseudo register for any time interval by filtering out any time intervals that occurred before the beginning of the time interval. The resulting HLL register can then be used to calculate the HLL (i.e. the probabilistic counter value).

In this way, an HLL value can re-calculated for any time interval for any data stream. Moreover, these 2-dimensional structures can be combined for multiple data streams or workloads prior to calculating the final HLL value or values. Further, an intersection of different data streams can be determined by comparing the 2-dimensional structures resulting from each data stream for any time interval therein. As such, it also permits for the union of non-disjoint sets (such as, but not limited to, reads and writes to the same disk or relating to the same workload). The HLL utilizes a register wherein the number of leading zeros for a given hashed sample is recorded and, using a small number of the trailing bits at the end of the hashed sample, a register is defined for a particular value. If the value in the register location is either empty or less than the number of leading zeros for the current hashed sample, the current value is placed into that location. If the value is greater, than the register is not updated. In the current embodiment, an HLL tracking matrix is established. The tracking matrix is an N×P matrix, where N is the number of entries in an HLL register and P is the number of leading zeros that are possible in given set of values. For each data element (or for each data element after a predetermined interval), (1) the data element is computed in the hash function; (2) count of leading zeros is determined from the result of the hash function and the register location is identified; (3) instead of recording the number of leading zeros, as per the standard HLL methodology, the sample time of the data element is stored in the column specified by the HLL register location and in the row associated with leading zero count (i.e. if there are p leading zeros, then the sample time for that data element is recorded in the p^{th} row and the n^{th} column, n corresponding uniquely to the register address associated with the hashed result, of the HLL tracking matrix).

A combined HLL register is then generated by placing in the combined register the number of leading zeros (i.e. the row number) associated with the highest count in each column after filtering for the appropriate time interval. This combined HLL provides a compressed collection of all distinct value counters in a given time interval. It is therefore possible to re-construct all the distinct value counters at any point in time, and intersections of any two HLL sets are possible. It also permits unions for non-disjoint sets (e.g. reads and writes to the same disk or workload). While examples of determining locality of data streams has been shown above in examples relating to data storage, and even more specifically, building MRC data for workloads on specific data storage resources, locality of data streams has numerous other applications.

The following description of such examples are intended to illustrate, not limit, the numerous other applications involving streams of data, all of which may be supported by the subject matter provided for herein. Some illustrative and non-limiting examples may include:
Assessing, possibly for planning and determining priorities and efficiencies, network traffic over a network of devices, where an understanding or uniqueness, or high frequency of the same values, with respect to data elements or aspects thereof is relevant to managing or scheduling traffic. For example, if there are a high number of similar IP packets (which may be different with respect to payload but identical in destination address), which can be assessed through the use and comparison of distinct value counters, certain network nodes or classes of IP packets (or other such data/protocol units) can be prioritized or deprioritized.
Assessing anomalous sequences in data streams. In some cases, such anomalous sequences may represent unusual activity in a data stream, including possible unauthorized communication indicative of a security breach or security threat. For example, anomalous sequences of system calls may indicate a security breach or threat. By identifying unique data elements, or data elements having a unique characteristic, whose uniqueness may be indicative of an anomalous access, an indication of a security threat or breach may be raised quickly and efficiently.
Assessing sequences in bioinformatics, which may involve high numbers of sequences for which understanding locality and/or cardinality may provide a benefit.
For web traffic management, knowing the number of unique visitors to a specific URL or network destination or node, and in particular how this may change over time, may give particular insight.

In some embodiments, the use of distinct value counters may have many uses and applications beyond the context of assessing locality of a data stream, including such data streams being processed in one or more of data compute and/or a data communications and/or data storage contexts. In any system involving a dynamic stream of data, information, objects, devices, people/animals or other entities, the methods described herein can be applied to identify or characterize unique or low-frequency events or occurrences, or the inverse, of highly repeated or high-frequency events or occurrence, as well as being able to distinguish between them. Embodiments hereof may provide methods and mechanisms for assessing the number of unique or low-frequency events occurring in any system; alternatively, an indication of the locality of any series of events or set of elements or information may be provided. As noted elsewhere, locality can provide an indication of uniqueness and/or frequency of occurrence for any given element or values in the series or set, or it can provide an overall indication for a given set or series of the number of distinct values and the frequency of occurrence of distinct values, including an indication of how long (or how many elements have occurred) between occurrences. For example, in addition to assessing a data stream, the methods and devices herein could be used to analyze the locality of physical and/or logical events or elements. Such physical and/or logical events or elements may underlie a given data stream that is used to generate distinct value counters, or the DVC may be generated on an assessment of the physical and/or logical events or elements themselves. For example, a DVC may be generated to assess traffic, access or usage patterns of identifiable vehicles, persons, data, devices, or entities at physical or logical locations. For example, in the context of vehicle or traffic management, traffic patterns at, for example, a given intersection, airspace/airport, bridge or location, as well as traffic usage at a plurality of intersections, airspace/airport, bridges or locations. Other examples may include traffic, access or usage patterns by people, vehicles, devices, locations, or any identifiable physical element or thing; it may also be used to identify physical occurrences or events. It may be used to analyze the locality of things and events occurring in the physical world, provided that such things and events are each identifiable, or some aspect or characteristic of such things and events are identifiable. Sometimes referred to as the “Internet of things” or IoT, there has been significant growth of the connectivity of physical devices and things to the internet (or other communications networks), in many cases where each such device or thing is associated with a unique IP address or other unique communications-related address identifier or endpoint. As such, devices and things are increasingly capable of connecting to a communications network and of sending information relating to that device or thing via the communications network. By providing the means for unique identification, and optionally including the ability to communicate a variety of information, embodiments hereof can provide locality-related information of a complex system of things or devices. This locality-related information may related to the devices or things themselves (e.g. location or state), or alternatively, of events or occurrences that include or related to such devices or things. The locality-related information may also relate to a characteristic or condition, or change thereto, of such device or thing. Accordingly, the use of the distinct value counter analysis can be used to characterize a wide variety of activities of streams or passage of data, objects, information, persons, or biologics; locality of a stream of such things, or information relating thereto, can provide significant information relating to behaviours and normal and abnormal conditions and changes in such behaviour (i.e. low degree of locality or uniqueness, to a high degree of uniqueness or locality).

For example, embodiments hereof can provide distinct value counters and thus an indication of locality for a series of things, when each thing is associated with a unique identifier and the existence or the condition of such a thing can be communicated or determined (e.g. an IP address along with network connectivity may accomplish these conditions). In many cases, a secondary device or thing may be associated with the device or thing, or stream or group thereof, which is being assessed for locality. For example, a mobile phone or car, each of which will have a unique IP address may be used as a proxy to assess the existence, location or condition of a person who owns or uses that phone or car. In this example, a stream of IP addresses, each associated with an individual mobile device or vehicle, can be assessed for locality. This assessment may identify unique occurrences relating to the mobile device or vehicle (and/or by proxy the owner or user of that mobile device or vehicle), or generally the lack or existence of unique occurrences, the degree of uniqueness of the foregoing (i.e. an indication of stack time or stack distance for unique occurrences), or the frequency of highly unique occurrences.

The following descriptions and examples are provided to illustrate and describe various functionalities and embodiments of the instantly disclosed subject matter; nothing in the following examples, which are for illustrative and descriptive purposes, should be considered as limiting, as other embodiments may be possible.

The generation of data representations in accordance with an exemplary embodiment, can process a week-long trace (i.e. data stream) of 13 enterprise servers, constituting a 2.9 GB trace, in 23 minutes using just 80 MB of RAM; this works out to almost 1.7 million requests processed per second, fast enough for online (i.e. real time) analysis. This data representation of the 2.9 GB trace consumes just 7.8 MB. By comparison, a C implementation of a tree-based optimization (see G. S. Almasi, C. Cascaval, and D. A. Padua. Calculating stack distances efficiently. In Proceedings of the 2002 workshop on memory system performance (MSP '02), pages 37-43, 2002, incorporated by reference herein) of Mattson's original stack algorithm (see R. L. Mattson, J. Gecsei, D. R. Slutz, and I. L. Traiger. Evaluation techniques for storage hierarchies. IBM Systems journal, 9(2):78-117, 1970, incorporated by reference herein) takes an impractically higher number of hours and data storage capacity, e.g. RAM, to process the same trace.

### Example 1

### Counter Stack Processing and Analysis from MSR Storage Traces

The following example shows an empirical demonstration that the time and space requirements of counter stack processing are sufficiently low for use in online analysis of real storage workloads. In this example, there is provided a well-studied collection of storage traces released by Microsoft Research in Cambridge (MSR); see D. Narayanan, A. Donnelly, and A. Rowstron. Write off-loading: Practical power management for enterprise storage. ACM Transactions on Storage (TOS), 4(3):10, 2008, which is incorporated herein by reference. The MSR traces record the disk activity (captured beneath the file system cache) of 13 servers with a combined total of 36 volumes. Notable workloads include a web proxy (prxy), a filer serving project directories (proj), a pair of source control servers (src1 and src2), a web server (web), as well as servers hm, mds, prn, rsrch, stg, ts, usr, and wdev. The raw traces comprise 417 million records and consume just over 5 GB in compressed CSV format. This example compares data representations generated according to embodiments of the subject matter disclosed herein to the ‘ground truth’ obtained from full trace analysis (using trace trees, the tree-based optimization of Mattson's algorithm), and, where applicable, to a recent approximation technique which derives estimated MRCs from average footprints (see X. Xiang, B. Bao, C. Ding, and Y. Gao. Linear-time modeling of program working set in shared cache. In Parallel Architectures and Compilation Techniques (PACT), 2011 International Conference on, pages 350-360. IEEE, 2011.). The example described below uses a sparse dictionary to reduce memory overhead.

The exemplary methods were conducted on a Dell PowerEdge R720 with two six-core Intel Xeon processors and 96 GB of RAM. Traces were read from high performance flash to eliminate disk IO bottlenecks. Results and figures for both ‘low’ and ‘high’ fidelity streams are shown in this example. The fidelity is controlled by adjusting the number of counters maintained in each stream; the parameters used in these experiments represent just two points of a wide spectrum, and were chosen in part to illustrate how accuracy can be traded for performance to meet individual needs. The resources required to convert a raw storage trace to a counter stack stream is first reported. The memory footprint for the conversion process is quite modest: converting the entire set of MSR traces to high-fidelity counter stacks can be done with about 80 MB of RAM (This is not a lower bound; additional reductions can be achieved at the expense of increased garbage collection activity in the JVM; for example, enforcing a heap limit of 32 MB increases processing time for the high-fidelity counter stack by about 15% and results in a maximum resident set size of 53 MB). The processing time is low as well: with a single core and a 256 MB heap, a Java implementation in this exemplary embodiment can produce a high fidelity stream at a throughput of 2.3 million requests per second. The size of counter stack streams can also be controlled by adjusting fidelity. Ignoring write requests, the full MSR workload consumes 2.9 GB in a compressed, binary format. This can be reduced to 854 MB by discarding latency values and capping timestamp resolutions at one second, and another 50 MB is shaved off through domain-specific compaction techniques like delta-encoding time and offset values. But as the table below shows, which sets out the resources required to create low and high fidelity counter stacks for the combined MSR workload, this is still 100 times larger than a high-fidelity counter stack representation.

| Fidelity | Time | Memory | Throughput | Storage |
|---|---|---|---|---|
| Low | 13 m | 78.5 MB | 3.07M | 348 KB |
| | | | recs/sec | |
| high | 23 m | 80.6 MB | 1.67M | 7.8 MB |
| | | | recs/sec | |

The compression achieved by counter stack streams may be workload-dependent. In this exemplary embodiment, high-fidelity streams of the MSR workloads are anywhere from 10 (rsrch) to 1,200 (prxy) times smaller than their compressed binary counterparts, with larger traces tending to compress better. A stream of the combined traces consumes just over 1 MB per day, meaning that weeks or even months of workload history can be retained at very reasonable storage costs. Once a trace has been converted to a counter stack stream, performing queries is very quick. For example, a stack distance histogram for the entire week-long MSR trace can be computed from the counter stack stream in just seconds, with negligible memory overheads. By comparison, computing the miss ratio curve for the MSR trace using a trace tree takes about a week and reaches peak memory consumption of 92 GB, while the average footprint technique requires 46 minutes and 23 GB of RAM (this is roughly comparable to the time required to create a high fidelity counter stack, but it produces a single MRC, whereas the counter stack can be used to generate many variations).

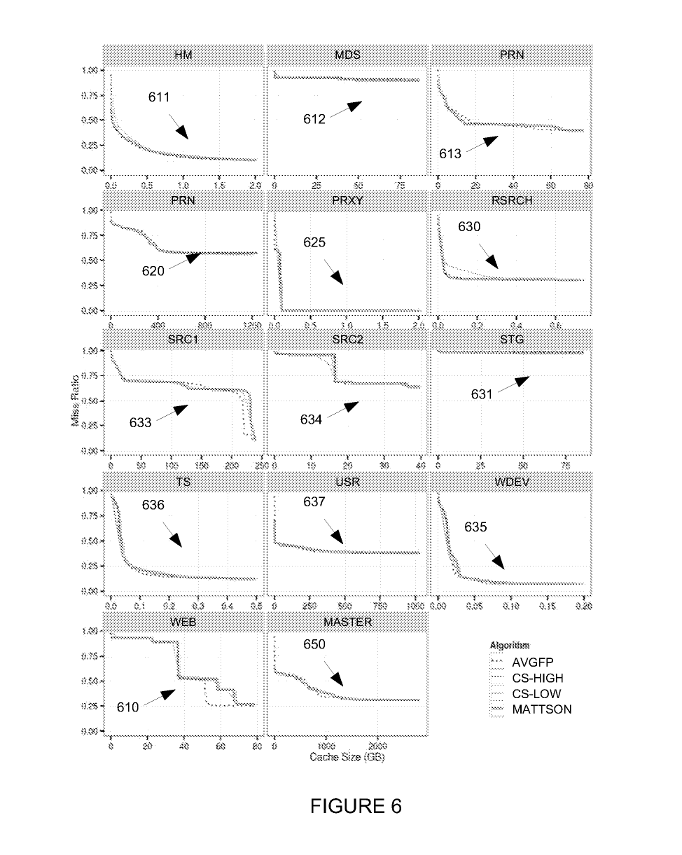

With reference to FIG. 6, there are shown miss ratio curves for each of the individual workloads contained in the MSR traces 611, 612, 613, 620, 625, 630, 633, 634, 631, 636, 637, 635, 610 as well as the combined master trace 650. As shown in the legend 660, there a multiple results superimposed onto the baseline curves (showing the exact MRCs based on a Mattson calculation) are the curves computed using footprint averages (avgfp) and counter stacks for both high and low fidelity. Some of the workloads feature MRCs that are notably different from the convex functions assumed previously, which can negatively impact the accuracy of existing approximation techniques. This is evident in the web MRC 610, where the average footprint technique deviates significantly from the ground truth for larger cache sizes. Counter stack estimations, in general, may be affected both by the error intrinsic to probabilistic counters and the uncertainty introduced by coarsening and pruning. Both of these error sources are visible in various MRC curves shown in FIG. 6. The high-fidelity MRC for rsrch 630 features a prominent non-monotonic blip which is the result of the amortized HyperLogLog update schedule. The counter stack MRCs for wdev 635, on the other hand, are monotonic, but deviate appreciably from the ground truth. This error is an artefact of the counter stack pruning optimizations, and could potentially be addressed by increasing the number of counters maintained for small stack distances. Note, however, that the latter class of errors are generally conservative, which is preferable for most use cases of MRC estimation.

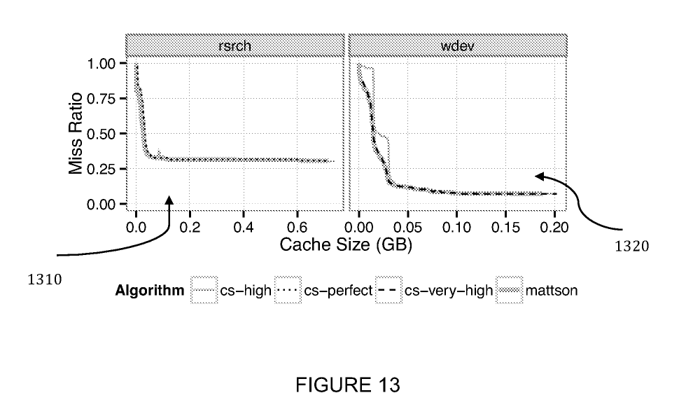

With reference to FIG. 13, there is shown the same MRCs for two workloads (rsrch 1310 and wdev 1320) alongside those computed with perfect counters. Perfect counters never produce negative results in the finite differencing scheme, so the resulting curve is for rsrch 1310 strictly monotonic. The counter stack MRCs for wdev 1320 are monotonic, but they deviate appreciably from the ground truth. This is likely because the counter stack for wdev 1320 produced with default parameters maintains relatively few counters for this workload due to its small size. As the curves for wdev 1320 show, increasing the fidelity of the counter stacks by maintaining more counters produces a much more accurate MRC.

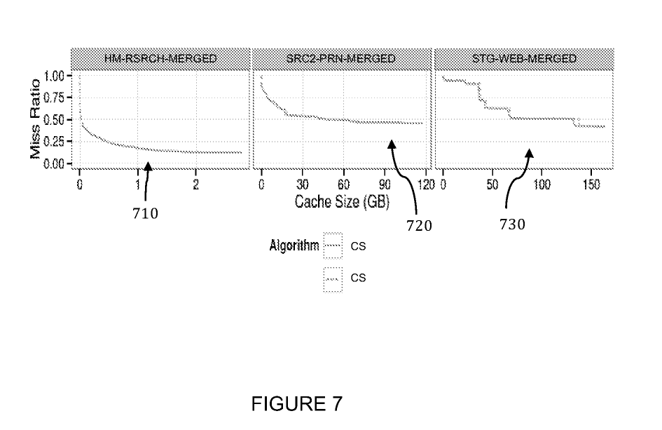

FIG. 7 shows three examples of MRCs 710, 720, 730 produced by joining individual counter stacks from workloads in the MSR; respectively, the mn-rsrch-merged MRC 710 shows the MSR resulting from the joined counter stacks from the data traces associated with hm and rsrch, the src1-web-merged MRC 720 shows the MSR resulting from the joined counter stacks from the data traces associated with src1 and web, and the src2-prn-merged MRC 730 shows the MSR resulting from the joined counter stacks from the data traces associated with src2 and prn. The MRCs shown were generated by utilizing the join operation of an HLL probabilistic counter to determine the combined counter stack. The choice of workloads for this example from the MSR is somewhat arbitrary; the joined workloads are of commensurate size so that each would contribute equally to the resulting merged MRC. As described elsewhere, the join operation can introduce additional uncertainty due to the need to infer the values of missing counters, but the effects are not prominent with at least some of the counter stacks used in these examples.

In embodiments, counter stacks may be used to produce MRC estimations with reduced time and space required by existing techniques; in some embodiments, counter stacks may be used to generate data representations of estimations of possible workloads (i.e. combined, intervals of, or split workloads), as well as being used to assess workloads from the data trace or the counter stack thereof.

In some embodiments, the counter stacks of separate workloads can be combined to assess the activity of such workloads if they were to be combined. For example, hit rates are often used to gauge the health of a storage system: high hit rates are considered a sign that a system is functioning properly, while poor hit rates suggest that tuning or configuration changes may be required. One problem with this simplistic view is that the combined hit rates of multiple independent workloads can be dominated by a single workload, thereby hiding potential problems. This problem is evident for the MSR traces shown in this example. The workload prxy features a small working set and a high activity rate—it accesses only 2 GB of unique data over the entire week but issues 15% of all read requests in the combined trace. With reference to the table below, it can be observed that the combined workload achieves a hit rate of 50% with a 550 GB cache; more than 250 GB of additional cache capacity would be required to achieve this same hit rate without the prxy workload.

| | |
|---|---|
| Desired Hit Rate | Required Cache Size |

| | |
|---|---|
| With prxy | Without prxy |

| | | | | |
|---|---|---|---|---|
| 30% | 2.5 | GB | 21.6 | GB |
| 40% | 19.2 | GB | 525.5 | GB |
| 50% | 566.6 | GB | 816.0 | GB |

The results in the above table illustrates why combined hit rate is not an adequate metric of system behavior. Diagnostic tools which present hit rates as an indicator of storage well-being should be careful to consider workloads independently as well as in combination. In embodiments, the counter stacks for what the resulting workload may be calculated and such counter stacks used to determine, for example, hit rate under different cache sizes.

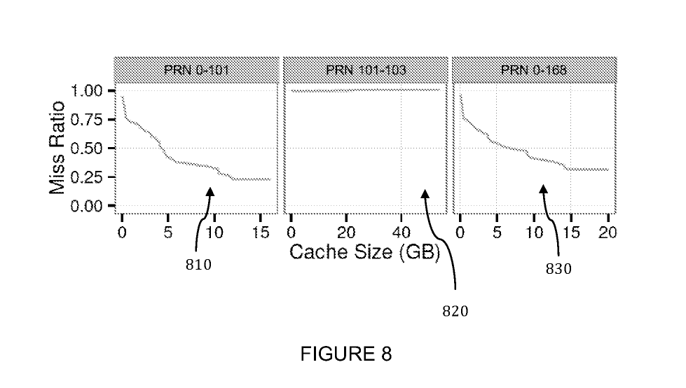

It has also been observed that MRCs can be very sensitive to anomalous or erratic events. For example, a one-off bulk read in the middle of an otherwise cache-friendly workload can produce an MRC showing high miss rates, arguably mischaracterizing the workload. As such, there is provided in one embodiment, a set of instructions on a computer readable medium, embodied as a script, that, when carried out by a computer processor, identifies erratic workloads by searching for time intervals within a given workload that may have unusually high or low miss ratios therein. In one exemplary embodiment, such a script found several workloads, in the MSR data trace, including mds, stg, ts, and prn, whose week-long MRCs are dominated by just a few hours of intense activity. With reference to FIG. 8, shows the effect these bursts can have on workload performance for prn, which shows the workload between hours 0 and 101 in the MRC denoted prn-0-101 810, the workload from hours 101 to 103 in the MRC denoted prn-101-103 820, and the workload from hours 103 to 168 in the MRC denoted prn-103-168 830. The full-week MRC for prn 613, which is shown for reference in FIG. 6, shows a maximum achievable hit rate of 60% at a cache size of 83 GB. However, when the script is run, the prn workload can be determined to feature a two hour read burst starting 102 hours into the trace which accounts for 29% of the total requests and 69% of the unique blocks. By utilizing embodiments disclosed herein, the counter stacks for the entire workload can be time-sliced into discrete workloads from which MRCs can then be calculated. The MRCs before 810 and after 830 in FIG. 8 shows this workload with the burst feature removed having hit rates of 60% at cache sizes of 10 GB and 12 GB, respectively. While the MRC of entire workload 613 shows that the data storage resources should be increased to approximately 18 GB for optimal hit rates for this workload, such a conclusion would be misleading. In fact, once the burst has been identified and multiple MRCs 810, 820, 830 are calculated separately for the workload, a system would be optimized by increasing the data storage resource associated with prn to 12 GB; the additional 6 GB that would have been added based on the MRC of the entire workload history would not improve the performance (the MRC of the burst 820 shows a 100% miss rate irrespective of the size of the data storage resource). As such, there can be provided a method of optimizing the appropriate amount of storage in a given data storage resource, wherein, after counter stacks are determined and MRCs have been assessed, an administrator or a system in an automated manner can, based on the MRC, calculate the amount of storage that should be added or removed to achieve an optimal miss rate (or, conversely, hit rate) for a given workload that is commensurate with the cost of the associated data storage resource for that workload. This example clear shows how anomalous events can significantly distort MRCs, and it shows why it is important to consider MRCs over various intervals in time, especially for long-lived workloads. Embodiments herein provide methods and systems for time-slicing the counter stack of a given workload into separate counter stacks that each represent time intervals thereof.

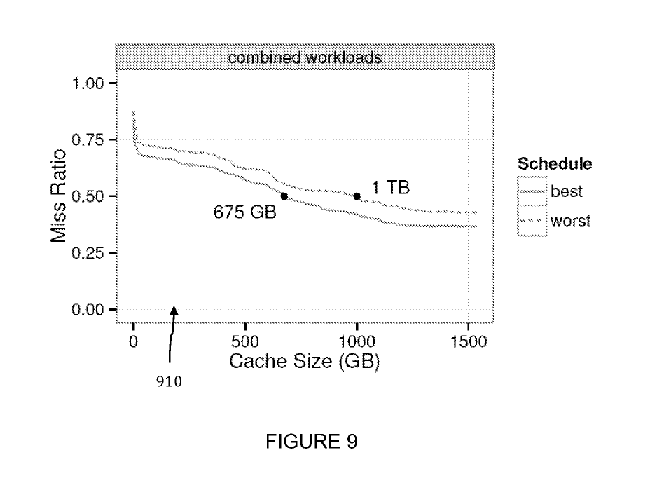

Many real-world workloads exhibit pronounced patterns associated with scheduling or time of day. For example, many workloads will exhibit diurnal patterns: interactive workloads typically reflect natural trends in business hours, while automatic workloads are often scheduled at regular intervals throughout the day or night. When such workloads are served by the same shared storage, it makes sense to try to limit the degree to which they interfere with one another. The time-shifting functionality of counter stacks provides a powerful tool for exploring coarse-grain scheduling of workloads. To demonstrate this, there is provided a script which computes the MRCs, shown in FIG. 9, of the combined MSR trace (excluding prxy) in which the start times of a few of the larger workloads (proj, src1, and usr) are shifted by up to six hours. FIG. 9 shows plots of the best and worst MRCs 910 computed by this script. As is evident, workload scheduling can significantly affect hit rates. In this case, shifting workloads by just a few hours increases the capacity needed for a 50% hit rate by almost 50%. In embodiments, therefore, there is provided a method for combining counter stacks for multiple workloads wherein the starting times for each workload can be adjusted, in some cases iteratively, to determine a plurality of counter stacks, and in some cases the resulting MRC or other analytical constructs, that would result if the data traces were in reality run with such offset times. The plurality of combined counter stacks can be used to determine optimal times for running workloads that may or may not conflict with one another.

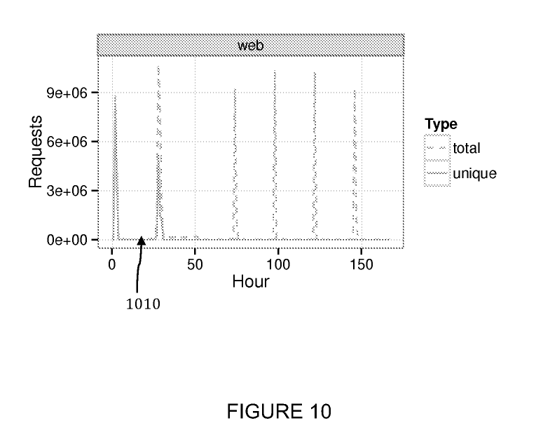

MRCs are good at characterizing the raw capacity needed to accommodate a given working set, but they provide very little information about how that capacity is used over time. In environments where many workloads share a common cache, this lack of temporal information can be problematic. For example, as the MRC for web 610 in FIG. 6 shows, the entire working set of web is less than 80 GB, and it exhibits a hit rate of 75% with a dedicated cache at this size. However, as shown in FIG. 10, which shows the total and unique requests per hour for the web workload, the workload is highly periodic and is idle for all but a few hours every day. This behavior is characteristic of automated tasks like nightly backups and indexing jobs, and it can be problematic because periodic workloads with long reuse distances (i.e. the stack distance tends to be high because there are long intervals where the data elements are not experienced in a workload) tend to perform poorly in shared caches. The cost of this is twofold: first, the periodic workloads exhibit low hit rates because their long reuse distances give them low priority in LRU caches; and second, they can penalize other workloads by repeatedly displacing ‘hotter’ data. This is exactly what happens to web in a cache shared with the rest of the MSR workloads: despite its modest working set size and high locality, it achieves a hit rate of just 7.5% in a 250 GB cache and 20% in a 500 GB cache. Scan-resistant replacement policies like ARC (Adaptive Replacement Cache) and CAR (Clock with Adaptive Replacement) offer one defense against this poor behavior by limiting the cache churn induced by periodic workloads. Embodiments herein provide methods and methodologies for an approach that exploits the regular nature of such workloads through identification and then intelligent prefetching. Counter stacks are well-suited for this task because they make it easy to detect periodic accesses to non-unique data. While this alone would not be sufficient to implement intelligent prefetching (because the counters do not indicate which blocks should be prefetched), it could be used to alert the system of the recurring pattern and initiate the capture of a more detailed trace for subsequent analysis. As such, there is provided a method for identifying periodic accesses to an increased number of non-unique data elements, or conversely, periodic accesses to an increased number of unique data elements. An example of a graph of a data construct showing this is in FIG. 10. The method may in some embodiments further comprise of identifying characteristics associated the data elements in during the periodic accesses to the increased number of non-unique data elements, and then pre-fetching the data associated with such data elements to higher performing data storage resources (i.e. flash, available resources, closer resources—where closer means fewer network hops away).

Embodiments may utilize synthetic workload generators, like FIO (see J. Axboe. Fio-flexible I/O tester, 2011.) and IOMeter [J. Sievert. Iometer: The I/O performance analysis

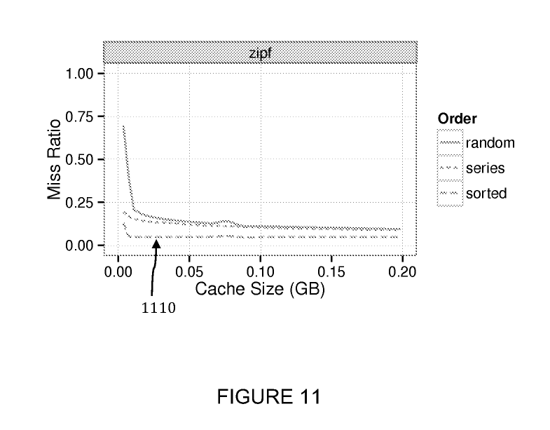

tool for servers, 2004.]. These and similar tools are commonly used to test and validate storage systems. They are capable of generating IO workloads based on parameters describing, among other things, read/write mix, queue depth, request size, and sequentiality. The simpler among them support various combinations of random and sequential patterns; FIO recently added support for Pareto and zipfian distributions, with the hope that these would better approximate real-world workloads. While moving from uniform random to zipfian distributions is a step in the right direction, it is not a panacea. Indeed, many of the MSR workloads, including hm, mds, and prn, exhibit roughly zipfian distributions. However, as is evident in FIG. 6, the MRCs of these workloads vary dramatically. With reference to FIG. 11, the MRC of a perfectly zipfian workload produced by FIO alongside two permutations of the same workload 1110; as expected, request ordering has a significant impact on locality and cache behavior. These figures show that synthetic zipfian workloads do not necessarily produce ‘realistic’ MRCs, emphasizing the importance of using real-world workloads when evaluating storage performance.

In some embodiments, the HLL determines a MRC for analyzing and/or optimizing a global workload on a data storage system. In many cases, however, there are multiple workloads being implemented on the same set of storage resources concurrently and, as such, there is provided in some embodiments a way of partitioning available data storage resources for some or each of a plurality of workloads in a way that ensures each workload is treated in given a subset of the available resources in a way that ensures each workload is treated appropriately, particularly, for some embodiments, recognizing the relative priorities of each workload.

In embodiments, it is possible to partition a given set of storage resources across specific workloads in a global set of data storage transactions wherein portions of memory for specific tiers of data storage are specifically designated for each workload, groups of workloads, or combinations thereof, from the aggregate workload on a data storage system. In some embodiments, an MRC can be determined for an aggregated workload (i.e. for all workloads concurrently sharing the same set of data storage resources). Portions in time of such aggregated workload can be “sliced” to assess an MRC for a particular workload for a particular time interval (since the MRC curve for a given time interval may be very different for another time interval, even an overlapping one, for the same workload). In another embodiment, the workloads can be disaggregated, and assessed by determining the MRC for each workload individually so as to determine the best partition size of available cache.

Because, for example, there may be instances wherein a single workload can be “pathological,” meaning that it would cause all other data from other workloads that may be processed in the data storage system to be evicted from the cache (or a higher tier of data storage) in a given setting, embodiments hereof determine what size of partitioned cache would be helpful for the “pathological” workload, while retaining other partitions for any other workloads being processed concurrently. Moreover, the specific partitions for each of the workloads can be optimized, including through optimizing them for their relative priority.

Since determining all possible combinations of partitioned cache sizes across all workloads at all times may be impractical, depending on the size and number of workloads and size and complexity of the data storage system and data tiers thereof, there are methods of estimating optimal or near-optimal partition sizes assignable for a given set of workloads.

In addition to providing a method for determining optimal partition sizes for each workload, the relative priority of different workloads can be accounted for by assessing the impact of preferring certain workloads over others in assigning partitioned space. By combining this concept with slicing techniques, partition sizes may be assigned/changed dynamically.

In one embodiment, the global workload being processed by the data storage system comprises of a plurality of individual workloads. For a given time period, a solver module calculates an individual MRC for each such individual workload. The solver module may also be provided with an indication of the relative priority of each such workload (such priority being determined automatically by the data storage system itself, or according to a request, setting or input by a user, data client, or system administrator). On the basis of each MRC, along with such input relating to the relative priority of each workload, the solver module then determines partition sizes for each workload for a range of global higher-tier data storage resource sizes (e.g. cache sizes). Based on the actual available higher-tier data storage resources available during the current time interval, the applicable partition of higher-tier data can be assigned to each workload (e.g. virtual machine).

In some embodiments, this may be repeated for successive time periods with a given frequency. In some embodiments, the frequency of assessing partitions of workloads may be different for a particular subset of the workload, wherein the remaining workloads are partitioned once or at different rate of analysis; the remaining workloads may also be assigned a specific sub-global higher-tier storage resource (e.g. portion of cache).

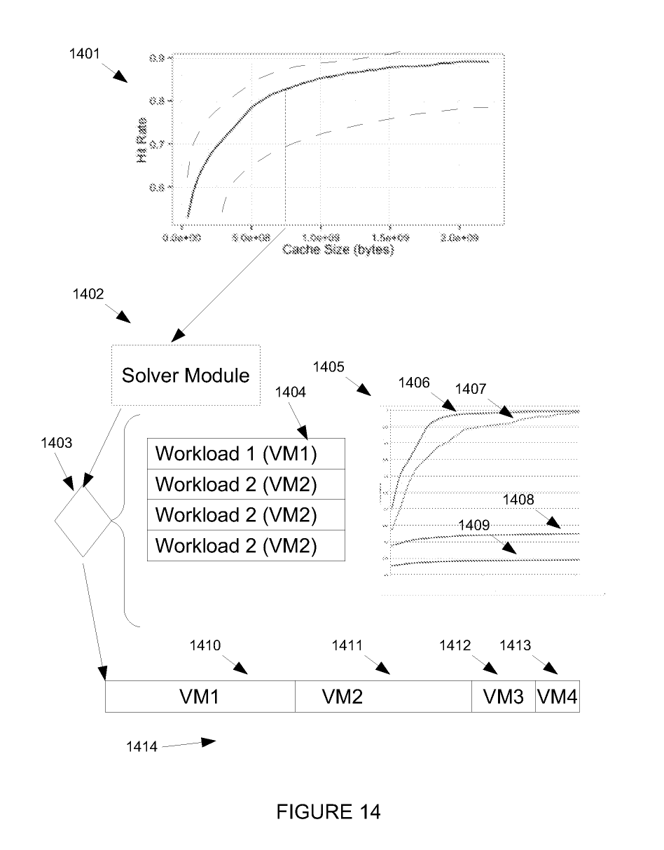

With reference to FIG. 14, there is shown an exemplary HRC 1401 for a given aggregate workload, which is indicative of the number of accesses to higher tier data storage that would return a result since the requested data has not been evicted from such higher tier data storage (i.e. a hit), when such data storage uses, for example, a Least Recently Used eviction model, across various data storage sizes for the given aggregate workload, where the y-axis indicates the cumulative hit frequency and the x-axis indicates the size of the data storage. FIG. 14 also shows how a solver module 1402 that is communicatively coupled to the data storage system can assess each workload and determine optimal, or near optimal, partitioning of data storage resources (where each partition constitutes the amount of higher tier data storage (e.g. cache) that is dedicated specifically for a given workload. Such dedication may or may not be a specific set of physical resources and the data storage system will ensure that at least that amount is available for processing data storage requests relating to the workload associated with each partition.

With reference to FIG. 14, the solver module 1402 further determines or analyzes (if calculated by another computing module on the data storage system) corresponding HRC curves 1405 for each workload 1404 making up the aggregated workload shown in the aggregate 1401. Each individual HRC 1406, 1407, 1408, 1409 can be used to determine an optimal allocation of higher tier storage (e.g. cache) for each individual workload making up the aggregate. In some embodiments, a value indicative of relative priority can also be associated with each workload, which may impact the allocation. The solver module may, in some embodiments, determine multiple allocations for every possible higher tier data storage size across a range of available data storage resources that may be used; in such embodiments, the total amount of data storage resources available for data storage processes may be variable or dynamic, and as such, the optimal partition may change over time. In some embodiments, as storage-side processing (including, for example, both routine administrative tasks such as garbage collection, or more application specific processing using live data directly on storage, such as data analysis or user-specific services, such as web servers or email servers) utilizes a variable level of storage side resources, more or less data storage resources, of any or all of the available data storage tiers may experience increased or reduced availability and, as such, the allocation and/or partitioning may change accordingly. The relative priority of other processes (being compute or storage) can be adjusted to ensure that data storage activity is prioritized, which may cause both allocation and partitioning of a given tier of data storage to be impacted. Variation in such capacity may be referred to as “stack space” and since such stack space change dynamically based on data storage workload activity, as well as ancillary processing thereof, allocation and partitioning values are determined dynamically by the solver module. As stack space changes, the partitioning that optimizes the use of the higher tier data storage resources, optionally in association with the relative priority of each work load (and possibly the priority of the processing of such data or other data on shared components of the data storage system), the optimal allocation for data storage and partitioning for each individual workload (e.g. each VM) running concurrently as an aggregate workload is implemented. With reference to FIG. 14, the solver module 1402 determines at step 1403, for each workload 1404 that forms a part of the aggregate workload, its own HRC curve 1406, 1407, 1408, 1409. Based on that information, the solver module 1402 generates a partitioning of available data storage resources for each workload at each of a range of different available levels of storage resources in the data storage system. At any given time the total amount of a given tier of data storage available for data storage processes may vary (depending on whether memory is required for other purposes, such as storage-side processing) and, as such, the solver module 1402 solves for a plurality of partitions, wherein the plurality of partitions are each associated with a given size of data storage across the full range of possible data storage sizes. Since the partition for any given size of available data storage in the tier may result in a very different allocation of data for each workload in the aggregate workload, a large number of partitions may be solved for. For example, a specific allocation/partition can be solved for a number of intervals of data storage sizes across the entire tier. Such intervals can be all the same size or different sizes for the same set of solved partitions. Depending on the processing capacity that the solver module provides to this solution, a higher number of smaller intervals can be solved for (thus providing higher resolution) or there can be a smaller number of larger intervals. In some embodiments, the solver will also incorporate a relatively priority when determining the partitioning and, as such, a higher priority workload may be provided with more higher tier data storage than would otherwise be provided for equal priorities. As shown in FIG. 14, a given partition of the available data storage 1414 at the specific tier being solved form, shows a different sized allocation of memory for each workload 1410, 1411, 1412, 1413 thus optimizing the amount of data storage at that tier that should be allocated for each workload.

While the present disclosure describes various exemplary embodiments, the disclosure is not so limited. To the contrary, the disclosure is intended to cover various modifications and equivalent arrangements included within the general scope of the present disclosure.

I/We claim:

1. A method for determining an indication of locality of data elements in a data stream communicated over a communication medium, the method comprising:
determining, for at least two sample times, count values of distinct values for each of at least two distinct value counters, wherein each of the distinct value counters has a unique starting time; and
comparing corresponding count values for at least two of the distinct value counters to determine an indication of locality of data elements in the data stream at one of the sample times.

2. The method of claim 1, wherein the determining occurs for every data element in the data stream by increasing the count value for each distinct value counter by one for a given data element if that data element was not part of the data stream since the starting time of the corresponding distinct value counter.

3. The method of claim 1, wherein the count value for at least one distinct value counter is determined by a probabilistic counter function.

4. The method of claim 3, wherein the probabilistic counter function comprises at least one of: HyperLogLog, SuperLogLog, LogLog, FM-85, Probabilistic Counting with Stochastic Averaging, K-Minimum Values, and a combination thereof.

5. The method of claim 1, wherein there is at least one counter interval between starting times for at least two of the unique distinct value counters.

6. The method of claim 5, wherein the at least one counter interval includes at least one of an interval time and a count of data elements.

7. The method of claim 3, wherein there is at least one sampling interval between at least two sample times.

8. The method of claim 7, wherein the at least one sampling interval includes at least one of an interval time and a count of data elements.

9. The method of any one of claims 1 to 8, wherein the comparing comprises determining for at least one pair of sample times the distinct value counter with the most recent starting time with no increase in counter value.

10. The method of any one of claims 1 to 9, wherein the indication of locality is used to determine stack distance.

11. The method of claim 10, further comprising outputting a graphical plot of the cumulative distribution of stack distances for a predetermined number of data elements in the data stream.

12. A method for converting at least one data stream of data elements on a communications medium into a data stream representation for providing an indication of locality of the data elements, the data stream representation comprising a plurality of distinct value counters, each distinct value counter having a unique count start time, the method comprising:
selecting a starting count time for the data stream;
for each of a plurality of distinct value counters commencing after the starting count time, determining at a first sample time a current count value;
storing the count value and sample time for each distinct value counter in the data stream representation; and
repeating the determining and storing for at least one other sample time.

13. The method of claim 12, wherein distinct value counters are commenced with every data element.

14. The method of one of claims 12 and 13, wherein the determining and the storing are repeated for every data element in the data stream.

15. The method of claim 14, wherein the determining is carried out by adding one to the previous counter value for each distinct value counter if the data element was not part of the data stream since the starting count time for the respective distinct value counter.

16. The method of any one of claims 12 to 14, wherein at least one of the distinct value counters is a probabilistic counter.

17. The method of claim 16, wherein the probabilistic counter function is at least one of the following: HyperLogLog, SuperLogLog, LogLog, FM-85, Probabilistic Counting with Stochastic Averaging, K-Minimum Values, and a combination thereof.

18. The method of claim 12, wherein there is a sampling interval between repeating the determining and the storing.

19. The method of claim 12, wherein there is a counting interval between starting times for at least two of the distinct value counters, wherein the counting interval is at least as great as the time between data elements in the data stream.

20. The method of claim 12, wherein the storing is not carried out for any distinct value counters having the same current counter value as one or more other distinct value counters with more recent starting times.

21. The method of claim 12, wherein the data stream representation is a representation of a combination of two or more data streams.

22. The method of claim 12, wherein the data stream representation is a representation of at least one data stream separated from a combined data stream.

23. The method of claim 12, wherein the data stream representation is a representation of a segment of data elements from a time interval during the one or more data streams.

24. A system for generating a data representation of workload characteristics of a data stream being processed on a data resource, the data stream comprising a plurality of data elements, the system comprising:
a data storage component for storing a data representation of the data stream, the data representation indicative of locality of the data elements;
a computer processing component configured to
generate, for at least two sample times, a counter value from each of a plurality of distinct value counters for the data stream, each distinct value counter having a unique start time; and
store the counter value and sample time for each distinct value counter in the data storage component.

25. The system of claim 21, wherein the computer processing component is further configured to determine an indication of the locality of the data elements for at least one of the sample times by comparing two or more distinct value counters.

26. The system of one of claims 21 and 22, wherein at least one of the distinct value counters is a probabilistic counter.

27. The system of any one of claims 21 to 23, wherein the probabilistic counter includes at least one of the following: HyperLogLog, SuperLogLog, LogLog, FM-85, Probabilistic Counting with Stochastic Averaging, K-Minimum Values, and a combination thereof.

28. The system of claim 21, wherein the data resource is a data storage facility.

29. The system of claim 25, wherein the data storage facility comprises a plurality of data storage tiers.

30. A method for converting at least one data stream into a probabilistic representation of the at least one data stream, the representation indicative of a probabilistic locality of data elements of the at least one data stream, the method comprising:
for a first data element in a first data stream of the at least one data stream, calculating a probabilistic hash function result at a first sample time;
generating from the probabilistic hash function result, a locality indicative value and a probabilistic register address;
storing the locality indicative value, probabilistic register address, and the sample time;
repeating the calculating and the generating for at least one other data element at another sample time.

31. The method of claim 30, further comprising:
generating a probabilistic register for a selected time interval associated with the at least one data streams by placing the locality indicative value associated with the largest sample time that is within the selected time interval into the probabilistic register at the probabilistic register address; and
calculating a probabilistic counter value from the probabilistic register.

32. A method for characterizing a data stream of discrete data elements, the method comprising:
defining a plurality of distinct data element counters each for respectively counting distinct data elements in said data stream over time, wherein said data element counters have unique start times;
determining respective increases between successive counts for at least two adjacent ones of said distinct data element counters;
comparing corresponding increases determined for said at least two adjacent ones of said distinct data element counters to output an indication as to a locality of at least some of the discrete data elements in the data stream as a result of said data element counters having unique start times; and
outputting said indication to characterize the data stream.

33. The method of claim 32, further comprising:
determining an indication of an upper bound and a lower bound to said locality as a function of: counting time interval magnitudes between said successive counts for said at least two consecutive ones of said distinct data element counters, and starting time interval magnitudes between said unique start times for at least two adjacent distinct data element counters.
